(19) United States
(12) Patent Application Publication
(10) Pub. No.: US 2026/0350438 A1
(43) Pub. Date: Nov. 5, 2026

(54) ADAPTIVE MEMORY MANAGEMENT FOR MULTI-AGENT INTERACTION SYSTEMS

(71) Applicant: Marcos Moreira Alves, Niterói RJ (BR)

(72) Inventor: Marcos Moreira Alves, Niterói RJ (BR)

(21) Appl. No.: 19/666,210

(22) Filed: May 2, 2026

Related U.S. Application Data
(60) Provisional application No. 63/799,694, filed on May 4, 2025.

(51) Int. Cl. G06N 5/04

(52) U.S. Cl. CPC G06N 5/04

(57) ABSTRACT

Disclosed is a computer-implemented method for automated interaction management includes receiving an input and retrieving information from a memory subsystem based at least in part on the input using a retrieval-augmented generation pipeline. The memory subsystem comprises a first memory component storing interaction data with a relevance attribute that attenuates over time, and a second memory component storing interaction events. The method further includes selecting at least one processing agent from one or more processing agents based at least in part on the retrieved information, generating a system response utilizing the at least one selected processing agent and the retrieved information, and maintaining interaction continuity across multiple interactions independent of session boundaries.

### RELATED APPLICATION

This application claims the benefit of U.S. Provisional Patent Application No. 63/799,694, filed May 4, 2025, entitled “Autonomous Agent Memory Framework Inspired by Human Cognition, Utilizing Multi-Component Storage with Logarithmic Contextual Decay and Episodic Memory for Enhanced Situational Awareness,” the entire disclosure of which is hereby incorporated by reference herein for all purposes.

### TECHNICAL FIELD

The present disclosure relates to systems and methods for managing automated interactions using adaptive memory and intelligent agent selection.

### BACKGROUND

Automated interaction systems, such as chatbots, virtual assistants, and customer service platforms, process user queries and generate responses using various computational techniques. These systems typically maintain some form of memory or context to track conversation history and user preferences. Conventional approaches to memory management in such systems often rely on fixed-size context windows, simple recency-based retention policies, or static retrieval methods that do not adapt to usage patterns over time. Similarly, routing user queries to appropriate processing agents or response generation modules typically involves rule-based logic or simple classification schemes that may not account for the full context of user interactions or the evolving capabilities of available agents.

### BRIEF DESCRIPTION OF THE DRAWINGS

The accompanying drawings, which are incorporated in and constitute a part of this specification, illustrate various embodiments of the present disclosure and, together and constitute a part of this specification, illustrate various embodiments of the present disclosure and, together with the description, serve to explain the principles of the disclosure.

FIG. 1 is a block diagram illustrating a unified multi-agent interaction management system with hybrid retrieval and adaptive memory according to an embodiment of the present disclosure.

FIG. 2 is a block diagram illustrating a memory subsystem with adaptive decay-based relevance management according to an embodiment of the present disclosure.

FIG. 3 is a block diagram illustrating an agent management module with multiple specialized processing agents according to an embodiment of the present disclosure.

FIG. 4 is a block diagram illustrating a hybrid retrieval architecture combining keyword-based and vector-based search according to an embodiment of the present disclosure.

FIG. 5 is a block diagram illustrating a routing module with intelligent agent selection capabilities according to an embodiment of the present disclosure.

FIG. 6 is a flowchart illustrating a method for managing automated interactions with adaptive memory according to an embodiment of the present disclosure.

FIG. 7 is a flowchart illustrating a method for performing hybrid search combining sparse keyword-based retrieval and dense vector-based semantic search according to an embodiment of the present disclosure.

### DETAILED DESCRIPTION

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The present disclosure relates to systems, methods, and computer-readable media for automated interaction management. In various embodiments, the disclosed techniques address limitations of conventional approaches by maintaining interaction continuity across multiple interactions independent of session boundaries, enabling context-aware response generation through a structured memory subsystem with time-attenuating relevance attributes.

In accordance with various embodiments of the present disclosure, a system to automate interaction management includes a processor and a memory subsystem coupled to the processor. The memory subsystem includes a first memory component configured to store interaction data, wherein a relevance attribute associated with the interaction data attenuates over time, and a second memory component configured to store interaction events. A query processing module implemented by the processor is configured to retrieve information from at least one of the first memory component and the second memory component. An agent management module implemented by the processor is configured to maintain one or more processing agents. A routing module implemented by the processor is configured to select at least one processing agent from the one or more processing agents based at least in part on information retrieved from the memory subsystem. A response generation module implemented by the processor is configured to produce system responses utilizing the at least one selected processing agent and retrieved information, wherein interaction continuity is maintained across multiple interactions independent of session boundaries.

In various embodiments, the relevance attribute may attenuate logarithmically based on elapsed time. The query processing module may implement a retrieval-augmented generation pipeline, and in some embodiments may implement a sparse-dense hybrid search combining sparse retrieval for exact keyword matches with dense vector search for semantic similarity. A cross-encoder re-ranker may generate relevance scores for results from the sparse retrieval and the dense vector search. In various embodiments, accessing interaction data in the first memory component resets an elapsed time parameter associated with the interaction data and applies a boost to the relevance attribute. A decay parameter governing attenuation of the relevance attribute may be dynamically adjusted based on interaction patterns, such as access frequency, recency of access, and session duration. The system may further include a conflict resolution module configured to resolve contradictions between the first memory component and the second memory component by prioritizing the first memory component when the relevance attribute exceeds a threshold. In various embodiments, the first memory component may comprise a vector database storing embeddings of the interaction data. The routing module may select the at least one processing agent based on a policy defining agent capabilities and routing rules, and the response generation module may generate system responses by providing retrieved information and a user input to the at least one selected processing agent as context.

In accordance with various embodiments of the present disclosure, a computer-implemented method for automated interaction management includes receiving an input and retrieving, by a processor, information from a memory subsystem based at least in part on the input using a retrieval-augmented generation pipeline. The memory subsystem includes a first memory component storing interaction data with a relevance attribute that attenuates over time and a second memory component storing interaction events. The method further includes selecting, by a processor, at least one processing agent from one or more processing agents based at least in part on the retrieved information, generating, by a processor, a system response utilizing the at least one selected processing agent and the retrieved information, and maintaining interaction continuity across multiple interactions independent of session boundaries.

In accordance with various embodiments of the present disclosure, a non-transitory computer-readable storage medium stores instructions that, when executed by a processor, cause the processor to receive an input, retrieve information from a memory subsystem based at least in part on the input using a retrieval-augmented generation pipeline, select at least one processing agent from one or more processing agents based at least in part on the retrieved information, generate a system response utilizing the at least one selected processing agent and the retrieved information, and maintain interaction continuity across multiple interactions independent of session boundaries. The memory subsystem includes a first memory component storing interaction data with a relevance attribute that attenuates over time and a second memory component storing interaction events.

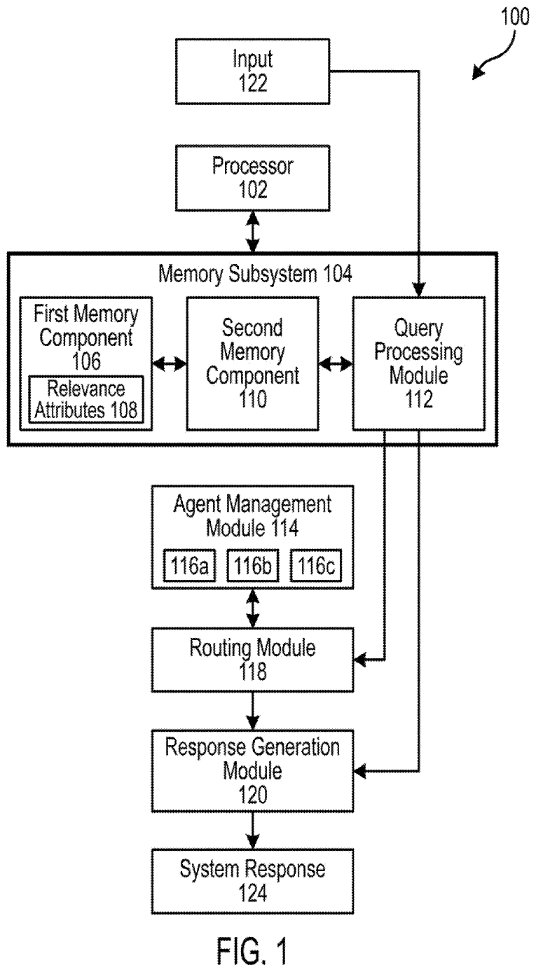

FIG. 1 is a block diagram illustrating an automated interaction management system 100 according to an embodiment of the present disclosure. The system 100 provides a comprehensive architecture for managing user interactions across multiple channels while maintaining persistent context independent of traditional session boundaries. As shown in FIG. 1, the system 100 comprises several interconnected modules that work in concert to receive user inputs, process them using intelligent agent selection, retrieve relevant contextual information from a sophisticated memory subsystem, and generate appropriate system responses.

The automated interaction management system 100 includes an input 122, a processor 102, a memory subsystem 104, an agent management module 114, a routing module 118, a response generation module 120, and a system response 124. These components are implemented on one or more processors coupled to non-transitory computer-readable storage media storing executable instructions. In various embodiments, the system 100 may be deployed on cloud infrastructure, on-premises servers, edge computing devices, or in hybrid configurations depending on latency requirements, data sovereignty considerations, and scalability needs.

The input 122 may serve as the entry point for user interactions, such as queries, and is configured to receive inputs from a variety of communication channels. In some embodiments, the input 122 supports synchronous channels such as web chat interfaces, mobile application messaging, voice calls, and real-time messaging platforms. In other embodiments, the input 122 supports asynchronous channels including email, SMS, social media direct messaging (e.g., WhatsApp, Telegram, Facebook Messenger), and API-based integrations. The input 122 normalizes incoming messages from heterogeneous sources into a standardized internal format, extracting metadata such as channel type, user identifier, timestamp, message content, and any attached media or files. This normalization enables downstream components to process interactions uniformly regardless of originating channel.

The processor 102 implements the various functional modules of the system 100 and coordinates the overall flow of interaction management. The processor 102 may comprise one or more central processing units (CPUs), graphics processing units (GPUs), application-specific integrated circuits (ASICs), or other processing hardware. In distributed embodiments, the processor 102 may represent a cluster of processing nodes working in coordination. The processor 102 is coupled to the memory subsystem 104 and implements the logic for the agent management module 114, routing module 118, and response generation module 120.

The memory subsystem 104 represents a core innovation of the present disclosure and comprises multiple memory components with different retention characteristics. As shown in FIG. 1, the memory subsystem 104 includes a first memory component 106, a second memory component 110, and a query processing module 112. The first memory component 106 is configured to store interaction data with associated relevance attributes 108 that attenuate over time, enabling the system to prioritize recent and frequently accessed information while gradually de-emphasizing older, less relevant data. The second memory component 110 is configured to store interaction events, providing a persistent record of significant occurrences such as completed transactions, escalations, user preferences, or notable conversation milestones. The query processing module 112 is implemented by the processor 102 and is configured to retrieve information from at least one of the first memory component 106 and the second memory component 110 in response to incoming user inputs.

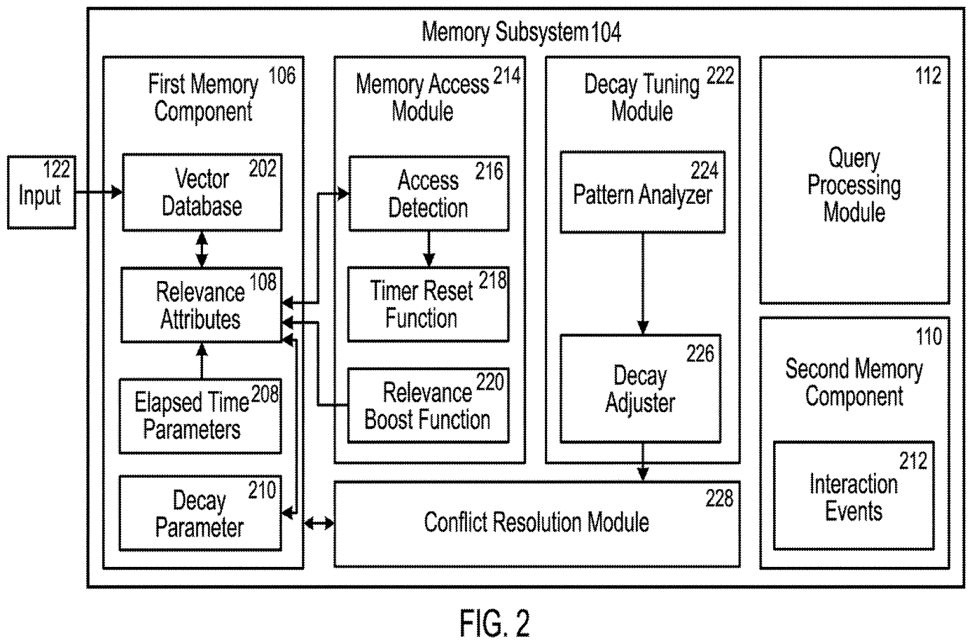

Unlike conventional session-based systems that discard context when a session ends, the memory subsystem 104 persists information across interaction boundaries, allowing users to resume conversations days, weeks, or months later with full contextual continuity. The memory subsystem 104 implements sophisticated retrieval mechanisms including keyword-based search, vector-based semantic search, and hybrid approaches that combine multiple retrieval strategies, as described in greater detail with reference to FIG. 2.

The agent management module 114 maintains a pool of specialized processing agents and provides mechanisms for agent registration, capability declaration, and lifecycle management. As shown in FIG. 1, the agent management module 114 may include but not be limited to processing agents 116a, 116b, 116c. Each processing agent may be optimized for particular types of tasks or domains. For example, in a customer service application, the agent management module 114 might maintain separate agents for order tracking (e.g., 116a), technical support (e.g., 116b), and billing inquiries (e.g., 116c). Each agent may be implemented using different underlying technologies, some may be rule-based systems, others may utilize large language models (LLMs) with specific fine-tuning or prompt engineering, and still others may integrate with external APIs or databases to perform specialized functions. In various embodiments, agents may be equipped with tool-use capabilities, enabling them to invoke external functions, access Model Context Protocol (MCP) servers for structured data retrieval, execute code via interpreters, utilize plugin architectures for extensibility, or employ skills frameworks that encapsulate reusable capabilities. For example, an agent might use function calling to query a database, invoke an MCP server to retrieve user files, execute Python code to perform calculations, or access a weather API to provide current conditions.

The routing module 118 implements intelligent agent selection logic that determines which processing agent from the agent management module 114 should handle a given user input. The routing module 118 receives information from the query processing module 112 of the memory subsystem 104 and analyzes the user input, retrieved contextual information, and declared capabilities of available agents to make routing decisions. In some embodiments, the routing module 118 implements a policy-based approach where routing rules are explicitly defined. In other embodiments, the routing module 118 utilizes machine learning models, such as classification models, ranking models, or reinforcement learning agents, that learn optimal routing strategies from historical interaction data. The routing module 118 may also implement fallback mechanisms, such as escalation to human operators when no suitable automated agent is available or when user frustration is detected.

The response generation module 120 is implemented by the processor 102 and is configured to produce system responses utilizing at least one selected processing agent from the agent management module 114 and retrieved information from the memory subsystem 104. The response generation module 120 receives the selected agent(s) from the routing module 118 and contextual information from the query processing module 112, then coordinates the generation of an appropriate response. In some embodiments, the response generation module 120 provides the retrieved context and user input to the selected agent as a prompt or input, receives the agent's output, and performs any necessary post-processing such as formatting, content filtering, or response validation.

The system response 124 represents the output delivered to the user via the appropriate communication channel. The system response 124 may be formatted appropriately for the target channel, for example, responses destined for a web chat interface may include rich formatting, buttons, and embedded media, while responses for SMS channels are formatted as plain text within character limits. The system 100 also handles delivery confirmation, retry logic for failed transmissions, and logging of outbound messages for audit and analysis purposes.

In operation in one embodiment, a typical interaction flow proceeds as follows: a user submits the input 122 via one of the supported channels. The processor 102 coordinates retrieval of relevant information from the memory subsystem 104 via the query processing module 112 based on the user input and user identifier. The routing module 118 analyzes the input and retrieved context to select an appropriate processing agent (116a, 116b, or 116c) from the agent management module 114. The selected agent processes the input using the retrieved context, and the response generation module 120 generates a response. The processor 102 updates the memory subsystem 104 with information from the current interaction, and the system response 124 is delivered (e.g., to the user) via the originating channel.

This architecture enables several key advantages over conventional interaction management systems. First, by decoupling memory management from session boundaries through the memory subsystem 104, the system 100 provides seamless continuity across interactions separated by arbitrary time intervals. Second, by implementing a multi-component memory architecture with different retention characteristics (first memory component 106 with attenuating relevance attributes 108, and second memory component 110 for persistent events), the system 100 balances the need for immediate contextual awareness with long-term knowledge retention. Third, by supporting multiple specialized agents (e.g., 116a, 116b, 116c) coordinated through intelligent routing (e.g., routing module 118), the system 100 can handle diverse interaction types more effectively than monolithic single-agent approaches. Fourth, by normalizing inputs 122 and outputs (e.g., system response 124) across heterogeneous channels, the system 100 enables users to switch channels mid-conversation without loss of context.

In various embodiments, the system 100 may be extended with additional modules not shown in FIG. 1. For example, an analytics module may track interaction metrics, agent performance, and user satisfaction scores. A training module may collect interaction data to improve agent capabilities or routing decisions. A security module may implement authentication, authorization, and encryption for sensitive interactions. An integration gateway may facilitate connections to external systems such as CRM platforms, databases, payment processors, or third-party APIs.

FIG. 2 is a block diagram illustrating the internal architecture of the memory subsystem 104 according to an embodiment of the present disclosure. As introduced with reference to FIG. 1, the memory subsystem 104 enables persistent context management across interaction boundaries through a multi-component memory architecture inspired by human cognitive systems. The memory subsystem 104 implements sophisticated mechanisms for storing interaction data with time-based relevance attenuation, detecting and responding to memory access patterns, dynamically tuning decay parameters based on usage patterns, and resolving conflicts between different memory components.

As shown in FIG. 2, the memory subsystem 104 comprises a first memory component 106, a second memory component 110, a query processing module 112, a memory access module 214, a decay tuning module 222, and a conflict resolution module 228. These components work in concert to provide a flexible, adaptive memory system that balances the competing needs of retaining recent contextual information, preserving important long-term knowledge, and efficiently retrieving relevant information in response to queries.

The first memory component 106 is configured to store interaction data wherein a relevance attribute associated with the interaction data attenuates over time. This component serves a function analogous to working memory or short-term memory in human cognition, maintaining readily accessible information about recent interactions while gradually de-emphasizing older information that has not been recently accessed or reinforced.

The first memory component 106 includes a vector database 202 that stores embeddings of interaction data. In various embodiments, the vector database 202 may be implemented using purpose-built vector database technologies such as Pinecone, Milvus, Weaviate, Qdrant, or ChromaDB. Alternatively, the vector database 202 may be implemented using vector search extensions to traditional databases, such as pgvector for PostgreSQL, or vector search capabilities within platforms like Elasticsearch or OpenSearch. The vector database 202 stores high-dimensional vector representations (embeddings) of interaction content, enabling semantic similarity search where queries can retrieve contextually relevant information even when exact keyword matches are absent.

Each item stored in the vector database 202 is associated with relevance attributes 108 that govern its priority and likelihood of retrieval. The relevance attributes 108 include multiple factors that collectively determine the current relevance of a stored item. In some embodiments, the relevance attributes 108 include a base relevance score assigned when the item is initially stored, which may reflect the inherent importance of the information (e.g., a completed transaction might receive a higher base score than a casual inquiry). The relevance attributes 108 also include a time-dependent component that attenuates based on elapsed time parameters 208, as described below.

The elapsed time parameters 208 may track temporal information associated with each stored item in the first memory component 106. In a typical embodiment, the elapsed time parameters 208 include a creation timestamp indicating when the item was first stored, a last access timestamp indicating when the item was most recently retrieved or referenced, and a calculated elapsed time value representing the duration since the last access. These parameters enable the system to compute time-based relevance decay.

The decay parameter 210 may govern, for example, the rate at which relevance attributes 108 attenuate over time. In some embodiments, the decay parameter 210 defines a logarithmic decay function where the relevance R(t) at time t is computed as: R(t)=R₀−k×log(1+Δt), where R₀ is the initial relevance score, k is the decay constant (e.g., decay parameter 210), and Δt is the elapsed time since last access (e.g., from elapsed time parameters 208). The logarithmic function provides a decay profile where relevance decreases rapidly in the initial period after storage or access, then decreases more gradually over longer time periods. This mirrors human memory characteristics where recently encountered information is highly accessible, but the rate of forgetting slows over time.

In alternative embodiments, the decay parameter 210 may define an exponential decay function: R(t)=R₀×e\hat{ }(−kΔt), where the relevance decreases exponentially with elapsed time. Exponential decay provides a different temporal profile that may be more appropriate for certain types of information or interaction patterns.

In still other embodiments, the decay parameter 210 may define a piecewise function, a power-law decay, or a hybrid approach that combines multiple decay functions. The specific decay function and parameter values may be configured globally for the system, customized per user or user segment, or adapted dynamically based on observed interaction patterns, as described below with reference to the decay tuning module 222.

The relevance attributes 108 are not purely time-dependent but may also incorporate other factors. In some embodiments, the relevance attributes 108 include an access frequency component that increases relevance for items that have been retrieved multiple times, reflecting the principle that frequently referenced information should remain more accessible. The relevance attributes 108 may also include a semantic importance score derived from natural language processing analysis of the content, a user-specified importance flag (e.g., if a user explicitly indicates “remember this”), or a contextual relevance score based on relationships to other stored items.

The second memory component 110 may be configured to store interaction events 212 that represent significant occurrences worthy of long-term retention. Unlike the first memory component 106 where relevance attenuates over time, the second memory component 110 provides persistent storage for important facts, milestones, and events that should remain accessible indefinitely or until explicitly superseded by newer information.

The interaction events 212 stored in the second memory component 110 may include a variety of event types. In some embodiments, interaction events 212 include transactional events such as completed purchases, booking confirmations, subscription changes, or payment transactions. In other embodiments, interaction events 212 include user preference declarations (e.g., “I prefer email communication,” “I'm allergic to peanuts,” “My preferred language is Spanish”). In still other embodiments, interaction events 212 include significant conversation milestones such as escalations to human operators, formal complaints, positive feedback, or resolution of complex issues.

The criteria for determining which interactions should be stored as interaction events 212 in the second memory component 110 may be implemented through various mechanisms. In some embodiments, specific interaction types are automatically flagged as salient based on predefined rules (e.g., any completed transaction, any explicit user preference statement). In other embodiments, natural language processing techniques such as named entity recognition (NER) identify important entities (names, dates, product IDs, case numbers) that should be preserved. In still other embodiments, sentiment analysis identifies interactions with strong emotional valence (highly positive or negative) as worthy of long-term storage. In another embodiment, a language model is prompted to evaluate conversation segments and extract salient facts for storage in the second memory component 110.

In some embodiments, the second memory component 110 also stores vector embeddings of the interaction events 212, enabling semantic retrieval similar to the first memory component 106. However, unlike the first memory component 106, these embeddings are not subject to time-based relevance decay. In other embodiments, the second memory component 110 stores interaction events 212 in a structured format (e.g., relational database records, JSON documents) optimized for exact-match queries or attribute-based filtering.

The query processing module 112 may be implemented by a processor, such as the processor 102 (FIG. 1) and is configured to retrieve information from at least one of the first memory component 106 and the second memory component 110 in response to incoming user inputs. The query processing module 112 may implement sophisticated retrieval strategies that may include keyword-based search, vector-based semantic search, hybrid approaches combining multiple retrieval methods, and filtering based on metadata attributes.

In some embodiments, the query processing module 112 implements a retrieval-augmented generation (RAG) pipeline. When a user input is received, the query processing module 112 generates a query embedding using the same embedding model employed for the vector database 202. This query embedding is then used to perform a semantic similarity search against the vector database 202, typically retrieving the top-k most similar items based on a distance metric such as cosine similarity, Euclidean distance, or dot product similarity.

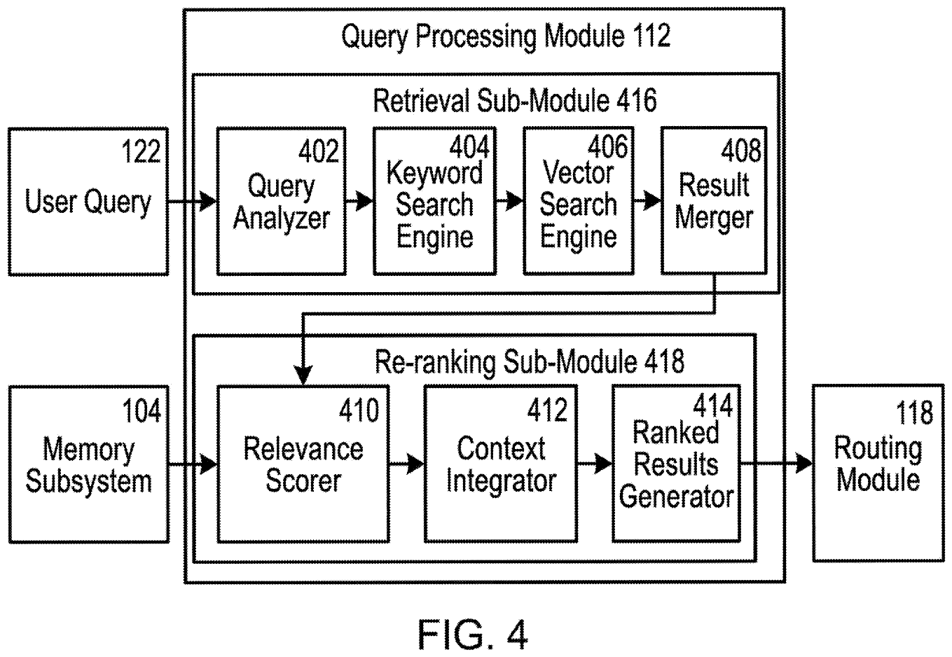

In other embodiments, the query processing module 112 implements a hybrid retrieval approach that combines sparse (keyword-based) retrieval with dense (vector-based) retrieval, as described in greater detail with reference to FIG. 4. The hybrid approach leverages the precision of keyword matching for exact-match queries while benefiting from the semantic understanding of vector search for conceptual queries.

The query processing module 112 may retrieve information from the first memory component 106, the second memory component 110, or both, depending on the nature of the query and the configured retrieval strategy. In some embodiments, the query processing module 112 queries both memory components in parallel and merges the results. In other embodiments, the query processing module 112 first queries the first memory component 106 for recent contextual information, and only queries the second memory component 110 if insufficient relevant information is found or if the query explicitly relates to long-term facts or events.

When retrieving information from the first memory component 106, the query processing module 112 may consider the current relevance attributes 108 of candidate items. Items with relevance scores below a configured threshold may be excluded from results, even if they exhibit high semantic similarity to the query. This ensures that highly decayed information does not pollute the context provided to downstream processing agents.

The memory access module 214 may be implemented by a processor such as processor 102 and is configured to detect access operations to interaction data in the first memory component 106 and to modify the relevance attributes 108 in response to such access. This implements a key innovation whereby accessing information “refreshes” its relevance, preventing premature decay of frequently referenced information and creating a self-reinforcing pattern where important information remains accessible.

The memory access module 214 includes an access detection component 216 that monitors retrieval operations performed by the query processing module 112. When the query processing module 112 retrieves an item from the first memory component 106 (e.g., as part of assembling context for a user query), the access detection component 216 identifies which specific items were accessed. In some embodiments, the access detection component 216 logs each access event with a timestamp and the identifier of the accessed item.

Upon detecting an access operation, the memory access module 214 may invoke a timer reset function 218 that resets the elapsed time parameters 208 associated with the accessed item. Specifically, the timer reset function 218 updates the last access timestamp to the current time, effectively resetting the Δt value used in the decay calculation to zero. This has the effect of restoring the item's time-dependent relevance component to its maximum value, as if the item had just been stored.

In addition to resetting the timer, the memory access module 214 may invoke a relevance boost function 220 that applies an additional increase to the relevance attributes 108 of the accessed item. The relevance boost function 220 may increment the base relevance score R₀, add a fixed boost value, or apply a multiplicative factor. In some embodiments, the magnitude of the boost applied by the relevance boost function 220 depends on the context of the access, for example, items that were highly relevant to the query (high similarity score) may receive a larger boost than items that were marginally relevant.

The combination of timer reset (e.g., via timer reset function 218) and relevance boost (e.g., via relevance boost function 220) creates a dynamic memory system where frequently accessed information naturally maintains high relevance, while information that is stored but never subsequently accessed gradually decays. This mirrors the “use it or lose it” principle observed in human memory systems.

This mechanism of resetting timers and boosting relevance upon access implements a principle analogous to spaced repetition in human learning and memory systems. In spaced repetition, information that is periodically reviewed and actively recalled is retained more effectively than information that is passively stored without reinforcement. Similarly, in the memory subsystem 104, information that is successfully retrieved and utilized by processing agents to resolve user queries—acting as a form of “cognitive reinforcement”—naturally persists in an accessible state with high relevance. When a contextual memory item (e.g., a variable, preference, or conversation detail) is accessed by an agent during prompt processing, the system triggers a read-update cycle: the Δt decay timer is reset (t₀ becomes the current timestamp) and a fractional boost is applied to the baseline detail score (D₀). This mathematically mimics the spacing effect in human learning, ensuring that frequently accessed short-term context does not decay while the conversation actively loops around that specific topic. Conversely, information that is stored but never subsequently referenced—analogous to information that is learned but never reviewed—gradually fades from prominence as its relevance attributes 108 attenuate according to the decay parameter 210.

In some embodiments, the memory access module 214 implements access frequency tracking, maintaining a count of how many times each item has been accessed. This access frequency may be incorporated into the relevance attributes 108, providing an additional dimension beyond time-based decay. Items with high access frequency may decay more slowly or may receive larger boosts from the relevance boost function 220.

The decay tuning module 222 is implemented by the processor 102 and is configured to dynamically adjust the decay parameter 210 based on observed interaction patterns. This enables the memory subsystem 104 to adapt its retention characteristics to the specific usage patterns of individual users, user segments, or application domains, optimizing the balance between retaining contextual information and avoiding clutter from obsolete data.

The decay tuning module 222 includes a pattern analyzer 224 that may analyze interaction patterns to identify characteristics relevant to memory retention. In some embodiments, the pattern analyzer 224 tracks metrics such as average time between interactions for a given user (inter-session interval), typical conversation length (number of turns per session), frequency of references to past interactions, and the temporal distribution of information reuse (e.g., whether users frequently reference information from days ago, weeks ago, or months ago).

Based on the patterns identified by the pattern analyzer 224, a decay adjuster 226 modifies the decay parameter 210 to better match the observed usage patterns. For example, if the pattern analyzer 224 determines that a particular user frequently returns after long gaps (e.g., weeks or months between interactions) and often references information from previous sessions, the decay adjuster 226 may decrease the decay constant k, resulting in slower decay and longer retention of contextual information. Conversely, if a user engages in frequent, short interactions with little reference to past context, the decay adjuster 226 may increase the decay constant k, allowing faster decay and prioritizing only the most recent information.

In some embodiments, the decay adjuster 226 adjusts decay parameters on a per-user basis, maintaining individualized decay parameter 210 values for each user. In other embodiments, the decay adjuster 226 identifies user segments or clusters with similar interaction patterns and applies segment-specific decay parameters. In still other embodiments, the decay adjuster 226 adjusts decay parameters globally based on aggregate system-wide patterns.

The pattern analyzer 224 may also identify temporal patterns in information relevance. For example, in a customer service context, information about an ongoing support case may be highly relevant for days or weeks but become largely irrelevant once the case is resolved. The pattern analyzer 224 can detect such patterns and the decay adjuster 226 can implement context-specific decay profiles, for instance, applying slower decay to information tagged as part of an “active case” and accelerating decay once the case status changes to “resolved.”

In some embodiments, the decay tuning module 222 implements machine learning models that predict optimal decay parameters based on features such as user demographics, interaction history, application domain, and observed outcomes (e.g., user satisfaction scores, task completion rates). The decay adjuster 226 then may apply the predicted optimal parameters.

In other embodiments, the decay tuning module 222 implements reinforcement learning (RL) to optimize decay parameters dynamically. In this approach, the pattern analyzer 224 and decay adjuster 226 together function as an RL agent operating within a Markov decision process framework. The state space includes user interaction patterns (e.g., inter-session intervals, conversation lengths, reference frequency), current decay parameter 210 values, and memory system performance metrics (e.g., retrieval precision, context utilization rates). Actions correspond to adjustments to the decay parameter 210, salience thresholds for promoting information to the second memory component 110, or other tunable parameters of the memory subsystem 104. Rewards are derived from observable outcomes such as user satisfaction scores (e.g., from post-interaction surveys or implicit feedback signals like task completion without escalation), task completion rates, retrieval effectiveness metrics, or efficiency measures (e.g., context window utilization). The RL agent learns a policy π(s) →a that maps observed states to optimal parameter adjustment actions, maximizing cumulative expected rewards over time. This enables the decay tuning module 222 to discover optimal tuning strategies that may not be apparent from hand-crafted rules or simple heuristics, and to continuously adapt to evolving user behavior, changing application requirements, or shifts in interaction patterns over time.

The conflict resolution module 228 is configured to resolve contradictions between information stored in the first memory component 106 and information stored in the second memory component 110. Such conflicts may arise when recent interaction data in the first memory component 106 contradicts or supersedes information stored as interaction events 212 in the second memory component 110, or vice versa.

In one embodiment, the conflict resolution module 228 implements an epistemic hierarchy where information from different memory components is prioritized based on recency and confidence. When a direct contradiction is detected, for example, if an interaction event 212 in the second memory component 110 indicates a user's shipping address is in New York, but recent interaction data in the first memory component 106 indicates the user has moved to Florida, the conflict resolution module 228 applies the following resolution strategy: First, the conflict resolution module 228 evaluates the relevance attributes 108 (including the current detail score D(t)) of the contradicting item from the first memory component 106 against a configured confidence threshold. If the relevance exceeds the threshold, the conflict resolution module 228 prioritizes the information from the first memory component 106 for the immediate session, reasoning that recent, high-confidence information should override older stored facts. Second, upon detecting such a contradiction, the conflict resolution module 228 triggers an asynchronous update/merge event. In some embodiments, this event spawns a background worker process (which may invoke a language model) to reconcile the conflicting information. The worker analyzes both the old fact (from the second memory component 110) and the new information (from the first memory component 106), determines whether the new information genuinely supersedes the old (e.g., a permanent address change) or represents a temporary exception (e.g., a one-time delivery to a different address), and updates the second memory component 110 accordingly. If the new information supersedes the old, the worker overwrites or appends the updated fact to the interaction events 212, effectively retiring the outdated information. This ensures that the second memory component 110 remains accurate over time while avoiding disruption to the current interaction.

In some embodiments, the conflict resolution module 228 implements a relevance-based prioritization strategy. When the query processing module 112 retrieves potentially conflicting information from both memory components, the conflict resolution module 228 compares the relevance attributes 108 of the item from the first memory component 106 against a configured threshold. If the relevance exceeds the threshold, the conflict resolution module 228 prioritizes the information from the first memory component 106, reasoning that recent, high-relevance information should take precedence over older stored events. If the relevance is below the threshold, the conflict resolution module 228 prioritizes the information from the second memory component 110, treating the persistent event as the authoritative source.

In other embodiments, the conflict resolution module 228 implements a recency-based strategy, always prioritizing the most recently stored or updated information regardless of which memory component contains it. In still other embodiments, the conflict resolution module 228 implements a source-based strategy, where certain types of information (e.g., explicit user preference statements) stored in the second memory component 110 always take precedence over inferred preferences in the first memory component 106.

In some embodiments, the conflict resolution module 228 employs a language model to analyze conflicting information and determine which is more likely to be correct or relevant given the current context. For example, if the second memory component 110 contains an interaction event indicating “user prefers email communication” but recent interactions in the first memory component 106 show the user consistently engaging via SMS, the conflict resolution module 228 might invoke a language model to reason about whether the user's preference has changed or whether the recent SMS usage is situational.

The conflict resolution module 228 may also trigger updates to the second memory component 110 when conflicts are resolved in favor of information from the first memory component 106. For instance, if recent high-relevance data contradicts a stored interaction event 212, the conflict resolution module 228 may update or replace the interaction event 212 to reflect the new information, ensuring that the second memory component 110 remains accurate over time.

In one embodiment in operation, the memory subsystem 104 functions as follows: When input (e.g., input 122 of FIG. 1) is received, the query processing module 112 generates appropriate queries against the first memory component 106 and/or second memory component 110. For the first memory component 106, this typically involves generating a query embedding and performing a vector similarity search against the vector database 202, with results filtered based on current relevance attributes 108 (which are computed from base scores, elapsed time parameters 208, and decay parameter 210).

As the query processing module 112 retrieves items from the first memory component 106, the access detection component 216 of the memory access module 214 detects these access operations. The timer reset function 218 updates the elapsed time parameters 208 for accessed items, and the relevance boost function 220 increases their relevance attributes 108. This ensures that information used in the current interaction maintains high relevance for future interactions.

Concurrently or subsequently, the query processing module 112 may retrieve interaction events 212 from the second memory component 110. If both memory components return relevant information, the conflict resolution module 228 analyzes the results for potential contradictions and applies its configured resolution strategy to determine which information should be prioritized or how conflicting information should be reconciled.

In the background, the pattern analyzer 224 of the decay tuning module 222 continuously or periodically analyzes interaction patterns. Based on this analysis, the decay adjuster 226 updates the decay parameter 210, adapting the memory retention characteristics to observed usage patterns. This creates a self-optimizing system that becomes better tuned to individual users or application domains over time.

The memory subsystem 104 may also implement background maintenance processes not explicitly shown in FIG. 2. For example, a garbage collection process may periodically identify items in the first memory component 106 whose relevance attributes 108 have decayed below a minimum threshold and remove them to conserve storage resources. A summarization process may periodically invoke a language model to generate summaries of clusters of related items in the first memory component 106, storing these summaries in the second memory component 110 as interaction events 212 while removing the original detailed items.

This sophisticated multi-component memory architecture enables the system 100 (FIG. 1) to maintain rich, persistent context across interaction boundaries while avoiding the accumulation of obsolete information, providing a foundation for truly continuous, context-aware automated interactions.

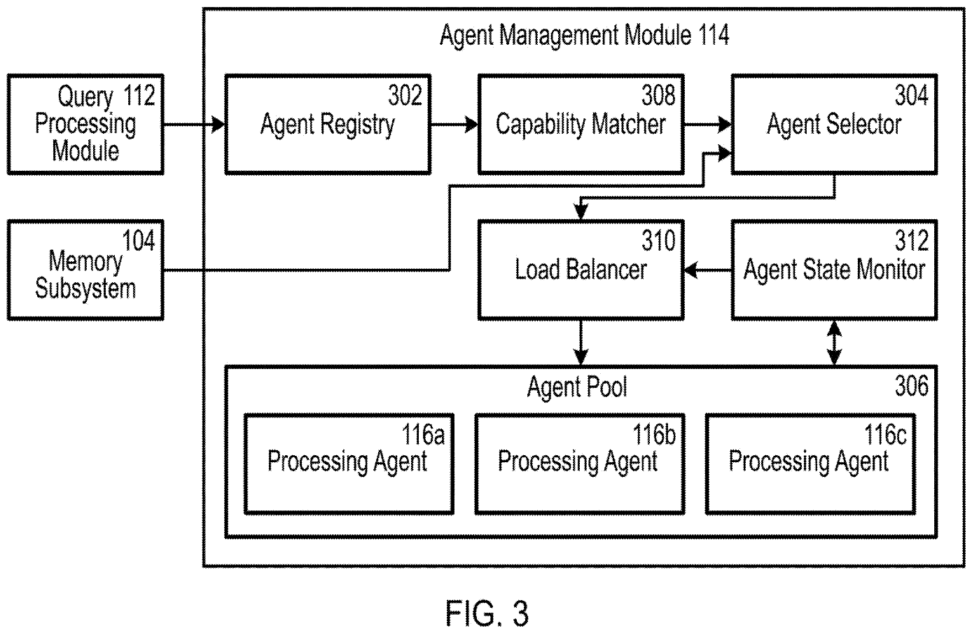

FIG. 3 is a block diagram illustrating the internal architecture of the agent management module 114 according to an embodiment of the present disclosure. As introduced with reference to FIG. 1, the agent management module 114 maintains a pool of specialized processing agents and orchestrates their selection and invocation based on incoming user requests and contextual information. The agent management module 114 implements sophisticated mechanisms for registering agent capabilities, matching those capabilities to user needs, selecting optimal agents from potentially multiple candidates, balancing load across available agent instances, and monitoring agent health and performance.

As shown in FIG. 3, the agent management module 114 comprises an agent registry 302, an agent selector 304, an agent pool 306, a capability matcher 308, a load balancer 310, and an agent state monitor 312. The agent management module 114 receives inputs from the query processing module 112 (which provides contextual information retrieved from the memory subsystem 104) and works in coordination with the memory subsystem 104 to make intelligent agent selection decisions.

The agent registry 302 maintains metadata about available processing agents, including their capabilities, configuration parameters, performance characteristics, and operational status. The agent registry 302 serves as a centralized catalog that enables dynamic agent discovery and selection without hard-coding agent identities or capabilities into the routing logic.

In some embodiments, the agent registry 302 stores structured records for each registered agent, where each record includes fields such as: agent identifier (a unique name or ID), agent type (e.g., “FAQ handler,” “order tracking,” “technical support,” “general conversation”), supported capabilities (a list of tasks or intents the agent can handle), required input parameters (what information the agent needs to function), output format (the structure of responses the agent produces), performance metrics (average response time, success rate, user satisfaction scores), cost parameters (computational cost, API usage costs for cloud-based agents), and operational constraints (maximum concurrent requests, rate limits, availability windows).

The agent registry 302 may be implemented as a database table, a configuration file (e.g., JSON or YAML), a service registry in a microservices architecture (e.g., Consul, etcd, Eureka), or a combination of these approaches. In some embodiments, agents self-register by calling an API endpoint of the agent registry 302 when they start up, providing their capability declarations and endpoint information. In other embodiments, agents are registered through an administrative interface or configuration management system.

The agent registry 302 supports dynamic updates, allowing new agents to be added, existing agents to be updated (e.g., capability expansions, endpoint changes), or agents to be removed without requiring system downtime. This enables continuous improvement of the system's capabilities and facilitates A/B testing of different agent implementations.

In other embodiments, the agent registry 302 maintains version information for agents, allowing multiple versions of the same agent to coexist. This supports gradual rollout strategies where a new version of an agent is initially deployed to handle a small percentage of requests, with the percentage gradually increased as confidence in the new version grows.

The capability matcher 308 analyzes incoming user requests and contextual information to determine what capabilities are needed to handle the request, then identifies agents from the agent registry 302 whose declared capabilities match those needs. The capability matcher 308 receives input from the query processing module 112, which provides both the raw user input and relevant contextual information retrieved from the memory subsystem 104.

In some embodiments, the capability matcher 308 implements a rule-based matching system. For example, if the user input contains keywords related to order status (e.g., “where is my order,” “track shipment”), the capability matcher 308 identifies agents in the agent registry 302 that declare “order tracking” as a supported capability. The rules may be simple keyword matching, regular expression patterns, or more sophisticated natural language understanding (NLU) techniques such as intent classification.

In other embodiments, the capability matcher 308 employs machine learning models to predict required capabilities. For instance, a trained classifier might analyze the user input and contextual features to predict one or more capability labels (e.g., “billing_inquiry,” “technical_support_level_2,” “product_recommendation”). The capability matcher 308 then queries the agent registry 302 for agents declaring those predicted capabilities.

The capability matcher 308 may identify multiple agents whose capabilities match the request. For example, both a specialized “order tracking agent” and a general-purpose “customer service agent” might be capable of handling an order status inquiry. In such cases, the capability matcher 308 provides the set of candidate agents to the agent selector 304 for final selection.

The capability matcher 308 also considers contextual information from the memory subsystem 104 when determining required capabilities. For example, if the memory subsystem 104 indicates that the user has an ongoing technical support case, the capability matcher 308 may prioritize agents with “technical support” capabilities even if the current user input is ambiguous. Similarly, if the user's interaction history shows a pattern of complex, multi-step requests, the capability matcher 308 may favor agents with advanced reasoning capabilities over simpler FAQ-style agents.

In some embodiments, the capability matcher 308 implements a scoring mechanism where each candidate agent receives a capability match score indicating how well its declared capabilities align with the identified needs. These scores are provided to the agent selector 304 to inform the final selection decision.

The agent selector 304 makes the final determination of which specific agent should handle a given request, selecting from the candidate agents identified by the capability matcher 308. The agent selector 304 implements selection logic that may consider multiple factors beyond capability matching, including agent performance characteristics, current load, cost, and policy constraints.

In some embodiments, the agent selector 304 implements a simple highest-score selection strategy, choosing the agent with the highest capability match score from the capability matcher 308. In other embodiments, the agent selector 304 implements a weighted scoring function that combines multiple factors:

Selection_Score=w₁×Capability_Match+w₂×Performance_Score +w₃×(1/Cost)+w₄×Availability, where the weights w₁, w₂, w₃, w₄ are configurable parameters that reflect organizational priorities (e.g., prioritizing performance over cost, or vice versa).

The agent selector 304 may retrieve performance metrics from the agent registry 302, such as average response time, success rate (percentage of requests successfully handled without errors or escalations), and user satisfaction scores (e.g., from post-interaction surveys or implicit feedback signals). Agents with better performance characteristics receive higher selection scores.

The agent selector 304 also considers cost parameters when multiple agents can handle a request. For example, if both a cloud-based large language model (with per-token API costs) and a locally-hosted rule-based system can handle a simple FAQ query, the agent selector 304 may prefer the lower-cost rule-based system. Conversely, for complex queries requiring sophisticated reasoning, the agent selector 304 may justify the higher cost of the advanced language model.

In some embodiments, the agent selector 304 implements policy-based constraints that override pure optimization. For example, a policy might specify that certain types of sensitive requests (e.g., involving personal health information, financial data) must be handled by specific certified agents, regardless of cost or performance considerations. Another policy might specify that requests from premium-tier customers should always be routed to the highest-capability agents.

The agent selector 304 receives availability and load information from the load balancer 310 and agent state monitor 312. If the optimal agent according to capability and performance metrics is currently overloaded or unavailable, the agent selector 304 selects an alternative agent from the candidate set. This ensures that agent selection accounts for real-time operational conditions, not just static capability declarations.

In some embodiments, the agent selector 304 implements reinforcement learning, where selection decisions are treated as actions in a Markov decision process. The agent selector 304 receives rewards based on outcomes (e.g., successful task completion, user satisfaction, efficiency) and learns a selection policy that maximizes cumulative rewards over time. This enables the agent selector 304 to discover optimal selection strategies that may not be obvious from hand-crafted rules or simple scoring functions.

The agent selector 304 also implements fallback mechanisms for cases where no suitable agent is available. In some embodiments, the fallback is to select a general-purpose agent that can handle a wide range of requests, albeit perhaps less effectively than a specialist. In other embodiments, the fallback is to escalate to a human operator. In still other embodiments, the fallback is to return a message to the user indicating that the system cannot currently handle the request and suggesting alternative channels or times.

The agent pool 306 represents the collection of actual processing agent instances available to handle requests. As shown in FIG. 3, the agent pool 306 contains the processing agents 116a, 116b, 116c introduced in FIG. 1, shown here in greater architectural detail within the agent management module 114. In practice, the agent pool 306 may contain many more agents of diverse types beyond the three illustrated.

Each processing agent (116a, 116b, 116c) is a software component capable of processing user inputs and generating responses. The implementation of processing agents varies widely depending on their purpose and the underlying technology. In some embodiments, a processing agent is a rule-based system that matches user inputs against predefined patterns and returns scripted responses. In other embodiments, a processing agent is a wrapper around a large language model (LLM) API, where the agent constructs appropriate prompts incorporating the user input and contextual information, calls the LLM API, and processes the returned response.

In still other embodiments, a processing agent integrates with external systems or databases. For example, the order tracking agent 116a example of FIG. 1 might query an order management database to retrieve shipment status, then format the results into a user-friendly response. In other embodiments, processing agents are equipped with tool-use capabilities, enabling them to dynamically select and invoke appropriate tools from a tool library based on task requirements. Such tools may include function calling interfaces to external APIs, Model Context Protocol (MCP) servers providing structured access to data sources (e.g., file systems, databases, web services), code execution environments (e.g., Python interpreters, sandboxed execution containers), plugin systems enabling modular capability extensions, or skills frameworks that encapsulate domain-specific procedures. The agent determines which tools to use based on the user request and available context, constructs appropriate tool invocations, processes tool outputs, and synthesizes results into coherent responses.

Processing agents may be stateless or stateful. Stateless agents process each request independently, relying on the memory subsystem 104 (FIG. 2) to provide necessary context. Stateful agents maintain internal state across multiple turns of a conversation, though this approach is less common in the present architecture due to the advantages of centralized context management in the memory subsystem 104.

The agent pool 306 may be implemented using various architectural patterns. In some embodiments, processing agents are deployed as microservices, each running in its own container or serverless function, with the agent pool 306 representing the collection of service endpoints. In other embodiments, processing agents are implemented as plugins or modules loaded into a common runtime environment. In still other embodiments, processing agents are external third-party services accessed via APIs.

The agent pool 306 supports horizontal scaling, where multiple instances of the same agent type can be deployed to handle increased load. For example, if the order tracking agent 116a experiences high demand, additional instances can be spawned and registered with the agent registry 302. The load balancer 310 then distributes requests across the available instances.

The load balancer 310 distributes requests across multiple instances of the same agent type when such instances exist in the agent pool 306. The load balancer 310 monitors the current load on each agent instance (via the agent state monitor 312) and routes new requests to instances with available capacity, preventing any single instance from becoming overwhelmed while others sit idle.

In some embodiments, the load balancer 310 implements a round-robin strategy, cycling through available instances of the selected agent type in sequence. In other embodiments, the load balancer 310 implements a least-connections strategy, routing each new request to the instance currently handling the fewest active requests. In still other embodiments, the load balancer 310 implements a weighted distribution based on the processing capacity of different instances (e.g., if some instances run on more powerful hardware, they receive proportionally more requests).

The load balancer 310 may receive real-time state information from the agent state monitor 312, including metrics such as current request queue depth, average response time, CPU utilization, and error rates for each agent instance. If an instance shows signs of degraded performance (e.g., increasing response times, elevated error rates), the load balancer may 310 reduce the proportion of requests routed to that instance or removes it from the rotation entirely until health is restored.

In some embodiments, the load balancer 310 implements geographic or network-aware routing, preferring agent instances that are physically or network-topologically closer to the user or to required data sources, minimizing latency. The load balancer 310 may also handle retry logic. If a request to an agent instance fails (e.g., due to a network error, timeout, or instance crash), the load balancer 310 automatically retries the request with a different instance of the same agent type, providing resilience against transient failures.

The agent state monitor 312 may continuously track the operational status, performance metrics, and health of agent instances in the agent pool 306. The agent state monitor 312 provides this information to the load balancer 310 (to inform load distribution decisions) and to the agent selector 304 (to inform agent selection decisions).

In some embodiments, the agent state monitor 312 implements active health checking, periodically sending probe requests to each agent instance and verifying that responses are received within expected timeframes. Instances that fail health checks are marked as unavailable and removed from the active pool until they recover.

The agent state monitor 312 collects performance metrics from agent instances, including: request count (total requests handled), success rate (percentage of requests completed without errors), average response time, error rate (percentage of requests resulting in errors), and resource utilization (CPU, memory, network bandwidth). These metrics may be reported by the agent instances themselves (push model) or collected by the agent state monitor 312 through monitoring APIs (pull model).

In some embodiments, the agent state monitor 312 implements anomaly detection, identifying unusual patterns in agent behavior that may indicate problems. For example, a sudden increase in response time or error rate might indicate that an agent instance is experiencing issues, even if it continues to pass basic health checks. The agent state monitor 312 can alert administrators or trigger automated remediation actions (e.g., restarting the problematic instance).

The agent state monitor 312 may also track longer-term performance trends, enabling capacity planning and performance optimization. For example, if the agent state monitor 312 observes that a particular agent type consistently operates near capacity during certain time periods, this information can inform decisions to deploy additional instances or to optimize the agent's implementation.

In other embodiments, the agent state monitor 312 tracks user satisfaction metrics associated with each agent. For example, if users frequently abandon conversations handled by a particular agent, or if post-interaction surveys show low satisfaction scores, the agent state monitor 312 flags this agent as potentially problematic. This information can inform agent selector 304 decisions (preferring higher-satisfaction agents) and can trigger reviews of the agent's implementation.

In one embodiment in operation, the agent management module 114 functions as follows: When a user request is received and contextual information has been retrieved by the query processing module 112, this information is provided to the capability matcher 308. The capability matcher 308 analyzes the request and context, determines what capabilities are needed, and queries the agent registry 302 to identify candidate agents with matching capabilities.

The capability matcher 308 may provide the set of candidate agents (potentially with capability match scores) to the agent selector 304. The agent selector 304 retrieves additional information about these candidates from the agent registry 302 (performance metrics, cost parameters, etc.) and from the agent state monitor 312 (current availability and health status). The agent selector 304 may then apply its selection logic, whether rule-based, scoring-based, policy-based, or learning-based, to choose the optimal agent for the request.

Once an agent is selected, the agent selector 304 may pass the selection to the load balancer 310 (if multiple instances of the selected agent type exist). The load balancer 310 consults the agent state monitor 312 to determine which specific instance should handle the request, considering current load distribution and instance health. The load balancer 310 then routes the request to the chosen instance in the agent pool 306.

The selected processing agent (116a, 116b, or 116c) may process the request using the provided user input and contextual information from the memory subsystem 104. The agent generates a response, which is returned through the agent management module 114 to the response generation module 120 (FIG. 1) for delivery to the user.

Throughout this process, the agent state monitor 312 may track the request and its outcome, updating performance metrics for the agent instance and agent type. If the request fails or times out, the load balancer 310 may retry with a different instance. If no instances are available or all instances are unhealthy, the agent selector 304 may select an alternative agent type or trigger a fallback mechanism.

This sophisticated agent management architecture enables the system 100 (FIG. 1) to leverage diverse specialized capabilities, dynamically adapt to changing load conditions, maintain high availability through redundancy and health monitoring, and continuously optimize agent selection based on observed performance. The modular design allows new agents to be added, updated, or removed without disrupting the overall system, supporting continuous evolution of the system's capabilities.

FIG. 4 is a block diagram illustrating the internal architecture of the query processing module 112 according to an embodiment of the present disclosure. As introduced with reference to FIGS. 1 and 2, the query processing module 112 is responsible for retrieving relevant information from the memory subsystem 104 in response to user queries. FIG. 4 reveals a sophisticated retrieval architecture that implements a hybrid search strategy combining keyword-based retrieval with vector-based semantic search, followed by intelligent re-ranking to produce optimally relevant results. This architecture represents a core innovation enabling the system to balance precision (finding exactly what was requested) with recall (finding semantically related information even when exact matches are absent).

As shown in FIG. 4, the query processing module 112 comprises a retrieval sub-module 416 and a re-ranking sub-module 418. The query processing module 112 receives input 122 (e.g., a user query) as input, accesses the memory subsystem 104 to retrieve candidate results, and provides ranked results 414 to the routing module 118 for use in agent selection and response generation.

The retrieval sub-module 416 implements a dual-path retrieval strategy that generates candidate results through both keyword-based and vector-based search mechanisms operating in parallel. This hybrid approach leverages the complementary strengths of sparse retrieval (e.g., exact keyword matches, acronyms, identifiers, and precise terminology) and dense retrieval (e.g., semantic similarity, paraphrases, and conceptual relationships).

The query analyzer 402 receives the input 122 and performs preprocessing and analysis to optimize retrieval performance. In some embodiments, the query analyzer 402 implements text normalization operations such as lowercasing, removal of special characters, tokenization, and stopword removal. These operations prepare the query for keyword-based retrieval by the keyword search engine 404.

In other embodiments, the query analyzer 402 performs query expansion, identifying synonyms, related terms, or alternative phrasings that should be included in the search. For example, a query containing “automobile” might be expanded to include “car” and “vehicle.” Query expansion can be implemented using thesaurus-based approaches, word embedding similarity, or language model-based paraphrase generation.

The query analyzer 402 may also perform query classification, determining the type or intent of the query to inform downstream processing. For example, the query analyzer 402 might classify queries as factual (seeking specific information), navigational (seeking a particular resource), or conversational (open-ended discussion). This classification can influence how the keyword search engine 404 and vector search engine 406 are configured or weighted.

In other embodiments, the query analyzer 402 implements query understanding using natural language processing techniques. This may include named entity recognition (identifying people, places, organizations, dates mentioned in the query), dependency parsing (understanding grammatical relationships), or semantic role labeling (identifying who did what to whom). The extracted semantic information can be used to construct more targeted searches.

The query analyzer 402 may also analyze the query in the context of the conversation history retrieved from the memory subsystem 104. For example, if the current query contains pronouns or references (“What about the blue one?”), the query analyzer 402 can resolve these references using prior conversation turns to construct a more complete query (“What about the blue widget model XYZ?”).

The keyword search engine 404 may implement sparse retrieval based on exact or fuzzy keyword matching. In some embodiments, the keyword search engine 404 implements the BM25 (Best Matching 25) ranking algorithm, which is a probabilistic ranking function widely used in information retrieval. BM25 scores documents based on term frequency (how often query terms appear in the document), inverse document frequency (how rare the query terms are across the corpus), and document length normalization.

The keyword search engine 404 is particularly valuable for queries involving exact identifiers such as order numbers, case IDs, product SKUs, technical part numbers, confirmation codes, tracking numbers, or other alphanumeric codes where exact matching is critical. While the vector search engine 406 (described below) excels at semantic similarity and conceptual matching, it may not reliably retrieve items based on precise identifier matches, as embedding models are optimized for semantic meaning rather than character-level precision. The hybrid approach combining keyword search engine 404 with vector search engine 406 ensures that both exact-match queries (e.g., “Where is order #A1B2C3?”) and conceptual queries (e.g., “What's the status of my recent purchase?”) are effectively supported. This complementary design leverages the precision of sparse retrieval for structured identifiers while benefiting from the recall and semantic understanding of dense retrieval for natural language queries.

The BM25 score for a document D given query Q is computed as: score(D,Q)=ΣIDF(qᵢ)×(f(qᵢ,D)×(k₁+1))/(f(qᵢ,D)+k₁×(1−b+b×|D|/avgdl)), where qᵢ are the query terms, f(qᵢ,D) is the frequency of term qᵢ in document D, |D| is the document length, avgdl is the average document length in the corpus, and k₁ and b are tuning parameters (typically k₁=1.2 to 2.0, b=0.75).

In other embodiments, the keyword search engine 404 implements TF-IDF (Term Frequency-Inverse Document Frequency) scoring, which is a simpler but still effective approach. In still other embodiments, the keyword search engine 404 implements boolean search with support for operators like AND, OR, NOT, and phrase matching.

The keyword search engine 404 may support fuzzy matching to handle misspellings or variations. For example, using edit distance (Levenshtein distance), the keyword search engine 404 can match “recieve” to “receive” or “color” to “colour.” The degree of fuzziness (maximum edit distance) can be configured based on term length.

The keyword search engine 404 operates on an inverted index of the content stored in the memory subsystem 104. The inverted index maps each unique term to a list of documents (or memory items) containing that term, along with positional information and frequency counts. This data structure enables efficient retrieval of documents matching query terms without scanning the entire corpus.

The keyword search engine 404 generates a first set of candidate results, typically the top-k documents according to the keyword-based scoring function (e.g., top 100 results by BM25 score). These candidates are passed to the result merger 408.

The BM25 score for a document D given query Q is computed as: score(D,Q)=ΣIDF(qᵢ)×(f(qᵢ,D)×(k₁+1))/(f(qᵢ,D)+k₁×(1−b+b×|D|/avgdl)), where qᵢ are the query terms, f(qᵢ,D) is the frequency of term qᵢ in document D, |D| is the document length, avgdl is the average document length in the corpus, and k₁ and b are tuning parameters (typically k₁=1.2 to 2.0, b=0.75).

In other embodiments, the keyword search engine 404 implements TF-IDF (Term Frequency-Inverse Document Frequency) scoring, which is a simpler but still effective approach. In still other embodiments, the keyword search engine 404 implements boolean search with support for operators like AND, OR, NOT, and phrase matching.

The keyword search engine 404 may support fuzzy matching to handle misspellings or variations. For example, using edit distance (Levenshtein distance), the keyword search engine 404 can match “recieve” to “receive” or “color” to “colour.” The degree of fuzziness (maximum edit distance) can be configured based on term length.

The keyword search engine 404 operates on an inverted index of the content stored in the memory subsystem 104. The inverted index maps each unique term to a list of documents (or memory items) containing that term, along with positional information and frequency counts. This data structure enables efficient retrieval of documents matching query terms without scanning the entire corpus.

The keyword search engine 404 generates a first set of candidate results, typically the top-k documents according to the keyword-based scoring function (e.g., top 100 results by BM25 score). These candidates are passed to the result merger 408.

The vector search engine 406 implements dense retrieval based on semantic similarity in a high-dimensional vector space. The vector search engine 406 operates on vector embeddings stored in the vector database 202 of the first memory component 106 (FIG. 2) and potentially on embeddings of interaction events 212 in the second memory component 110.

The vector search engine 406 may first generate a query embedding by passing the input 122 (potentially after preprocessing by the query analyzer 402) through an embedding model. In some embodiments, the embedding model is a sentence transformer such as models from the sentence-transformers library (e.g., all-MiniLM-L6-v2, all-mpnet-base-v2, or multilingual variants like paraphrase-multilingual-mpnet-base-v2). These models are specifically trained to produce embeddings where semantically similar texts have high cosine similarity.

In other embodiments, the embedding model is accessed via an API, such as OpenAI's text-embedding-ada-002, text-embedding-3-small, or text-embedding-3-large models, Cohere's embed-english-v3.0 or embed-multilingual-v3.0, or Google's textembedding-gecko models. These API-based models often provide high-quality embeddings but incur per-request costs.

The dimensionality of the embeddings depends on the chosen model. For example, all-MiniLM-L6-v2 produces 384-dimensional vectors, text-embedding-ada-002 produces 1536-dimensional vectors, and text-embedding-3-large can produce embeddings of configurable dimensionality (256, 1024, or 3072 dimensions).

Once the query embedding is generated, the vector search engine 406 performs a similarity search against the stored embeddings in the memory subsystem 104. The similarity metric is typically cosine similarity, computed as: cosine_similarity(A,B)=(A·B)/(∥A∥×∥B∥), where A and B are embedding vectors, A ·B is the dot product, and ∥A∥ and ∥B∥ are the vector magnitudes. Cosine similarity ranges from −1 to 1, with 1 indicating identical direction (maximum similarity) and −1 indicating opposite direction.

Alternatively, the vector search engine 406 may use Euclidean distance (L2 distance) or dot product similarity as the distance metric, depending on the embedding model characteristics and whether the embeddings are normalized.

For efficiency, the vector search engine 406 typically implements approximate nearest neighbor (ANN) search rather than exact search. ANN algorithms such as HNSW (Hierarchical Navigable Small World), IVF (Inverted File Index), or LSH (Locality-Sensitive Hashing) enable fast retrieval from large vector databases by trading a small amount of accuracy for significant speed improvements.

The vector search engine 406 generates a second set of candidate results, typically the top-k documents (e.g., top 100) with highest semantic similarity to the query embedding. These candidates are passed to the result merger 408.

The result merger 408 combines the first set of candidate results from the keyword search engine 404 with the second set of candidate results from the vector search engine 406 to produce a unified candidate set for re-ranking. The result merger 408 handles deduplication (since the same document may appear in both result sets) and may apply preliminary scoring or weighting.

In some embodiments, the result merger 408 implements a simple union operation, collecting all unique documents that appear in either result set. Each document retains its scores from both retrieval paths (keyword score and vector similarity score), which may be used by the re-ranking sub-module 418.

In other embodiments, the result merger 408 implements reciprocal rank fusion (RRF), which combines rankings from multiple sources using the formula: RRF_score(d)=Σ1/(k+rank_i(d)), where rank_i(d) is the rank of document d in result set i, and k is a constant (typically 60). RRF is particularly effective because it doesn't require score normalization—it works purely on rank positions.

In still other embodiments, the result merger 408 implements a weighted linear combination of normalized scores: combined_score(d)=α×normalized_keyword_score(d)+β×normalized_vector_score(d), where α and β are weighting parameters (with α+β=1) that control the relative importance of keyword versus semantic matching. The weights may be configured globally, adjusted per query type (based on query analyzer 402 classification), or learned from user feedback.

The result merger 408 may also filter results based on metadata criteria. For example, results may be filtered by date range, source type, user permissions, or relevance attributes 108 from the first memory component 106 (ensuring that highly decayed items are excluded even if they match the query). The merged and potentially pre-scored candidate results are passed to the re-ranking sub-module 418 for final relevance assessment.

The re-ranking sub-module 418 may perform sophisticated relevance scoring on the candidate results from the retrieval sub-module 416, taking into account not only query-document similarity but also broader contextual factors. The re-ranking sub-module 418 produces a final ranked result set 414 optimized for relevance to a user's information need.

The relevance scorer 410 generates refined relevance scores for each candidate result. In some embodiments, the relevance scorer 410 implements a cross-encoder model, which represents a significant advancement over the bi-encoder approach used in the vector search engine 406.

While bi-encoders (used in the vector search engine 406) encode the query and documents independently and compute similarity via vector operations, cross-encoders process the query and each candidate document together as a single input. This allows the cross-encoder to model fine-grained interactions between query terms and document terms, producing more accurate relevance scores.

A typical cross-encoder architecture is based on transformer models such as BERT, RoBERTa, or their variants. The input to the cross-encoder is a concatenated sequence: [CLS] query [SEP] document [SEP], where [CLS] and [SEP] are special tokens. The transformer processes this sequence, and the final hidden state of the [CLS] token is passed through a classification head to produce a relevance score (typically a probability that the document is relevant to the query).

Popular cross-encoder models include ms-marco-MiniLM-L-6-v2, ms-marco-electra-base, and cross-encoder/ms-marco-TinyBERT-L-2-v2 from the sentence-transformers library, which are specifically trained on relevance judgment datasets like MS MARCO.

The relevance scorer 410 applies the cross-encoder model to each candidate result, generating a relevance score that reflects the model's assessment of how well the document answers the query. These scores may be more accurate than the initial retrieval scores because the cross-encoder can model complex semantic relationships.

In some embodiments, the relevance scorer 410 combines cross-encoder scores with the original retrieval scores (keyword and vector scores) using a weighted combination or learned ranking function. In other embodiments, the cross-encoder scores are used directly, replacing the initial scores.

The computational cost of cross-encoders is higher than bi-encoders because each query-document pair must be processed independently (whereas bi-encoders can pre-compute document embeddings). This is why cross-encoders are typically used for re-ranking a relatively small candidate set (e.g., top 100 results) rather than for initial retrieval from a large corpus.

The context integrator 412 incorporates additional contextual information from the memory subsystem 104 into the relevance assessment. While the relevance scorer 410 focuses on query-document similarity, the context integrator 412 considers broader factors such as conversation history, user preferences, temporal relevance, and relationships between results.

In some embodiments, the context integrator 412 retrieves recent conversation history from the memory subsystem 104 and identifies topics, entities, or themes that have been discussed. Results that relate to these ongoing topics receive a contextual boost, even if their direct query similarity is moderate. For example, if the user has been discussing “project Alpha” in recent turns, a result mentioning “project Alpha” receives higher priority even if the current query doesn't explicitly mention it.

The context integrator 412 may also retrieve user preferences or profile information from the second memory component 110 (interaction events 212). For example, if the user has previously indicated a preference for detailed technical explanations over simplified summaries, results matching that preference style receive higher scores.

In some embodiments, the context integrator 412 implements temporal relevance scoring, boosting results that are temporally aligned with the query or conversation context. For example, if the query relates to recent events, newer results receive higher scores. Conversely, for historical queries, older results may be prioritized.

The context integrator 412 may also analyze relationships between candidate results. For example, if multiple results discuss related topics or reference each other, the context integrator 412 can identify clusters of related information and ensure that the final ranked set includes diverse perspectives rather than redundant near-duplicates.

In some embodiments, the context integrator 412 employs a language model to perform contextual reasoning. The language model receives the query, conversation history, and candidate results, and generates contextual relevance assessments or explanations of why particular results are relevant given the broader context.

The ranked results generator 414 produces the final ranked result set based on the relevance scores from the relevance scorer 410 and contextual adjustments from the context integrator 412. The ranked results generator 414 sorts the candidate results by their final combined scores and selects the top-n results (where n is configured based on downstream requirements, typically 3-10 results for context provision to language models).

In some embodiments, the ranked results generator 414 implements diversity-aware ranking, ensuring that the top results cover different aspects or perspectives rather than being redundant. For example, maximal marginal relevance (MMR) is a technique that balances relevance with diversity: MMR=arg max [λ×Relevance(d,q)−(1−λ)×max Similarity(d,d′)]d∈R\Sd′∈S, where R is the candidate set, S is the already-selected results, λ controls the relevance-diversity tradeoff, and the algorithm iteratively selects results that are relevant to the query but dissimilar to already-selected results.

The ranked results generator 414 may also implement result presentation formatting, preparing the results for consumption by downstream components. This may include extracting relevant snippets or passages from longer documents, highlighting query terms, or generating brief summaries.

The final ranked result set 414 is provided to the routing module 118 (FIG. 1), where it informs agent selection decisions, and ultimately to the selected processing agent, where it serves as context for response generation.

In one embodiment in operation, the query processing module 112 functions as follows: the input 122 is received and passed to the query analyzer 402, which performs preprocessing, normalization, and potentially query expansion or classification. The processed query is then provided to both the keyword search engine 404 and the vector search engine 406, which operate in parallel.

The keyword search engine 404 may perform sparse retrieval against an inverted index of the memory subsystem 104 content, generating a first set of candidate results based on keyword matching and scoring (e.g., BM25). Simultaneously, the vector search engine 406 generates a query embedding and performs dense retrieval via approximate nearest neighbor search against the vector database 202, generating a second set of candidate results based on semantic similarity.

The result merger 408 may combine these two candidate sets, handling deduplication and potentially applying preliminary scoring or fusion techniques like reciprocal rank fusion. The merged candidate set is passed to the re-ranking sub-module 418.

The relevance scorer 410 may apply a cross-encoder model to each candidate, generating refined relevance scores based on fine-grained query-document interaction modeling. The context integrator 412 retrieves additional contextual information from the memory subsystem 104 (conversation history, user preferences, temporal context) and adjusts relevance scores to account for these broader factors.

Finally, the ranked results generator 414 combines the relevance scores and contextual adjustments, sorts the candidates, applies any diversity or presentation logic, and produces the final ranked result set 414. This ranked set is provided to the routing module 118 for use in agent selection and to the selected processing agent for use in response generation.

This hybrid retrieval and re-ranking architecture enables the system to achieve both high precision (finding exactly what was requested via keyword matching) and high recall (finding semantically related information via vector search), while also accounting for conversational context and user preferences. The result is a retrieval system that provides highly relevant information to support accurate, contextual automated interactions.

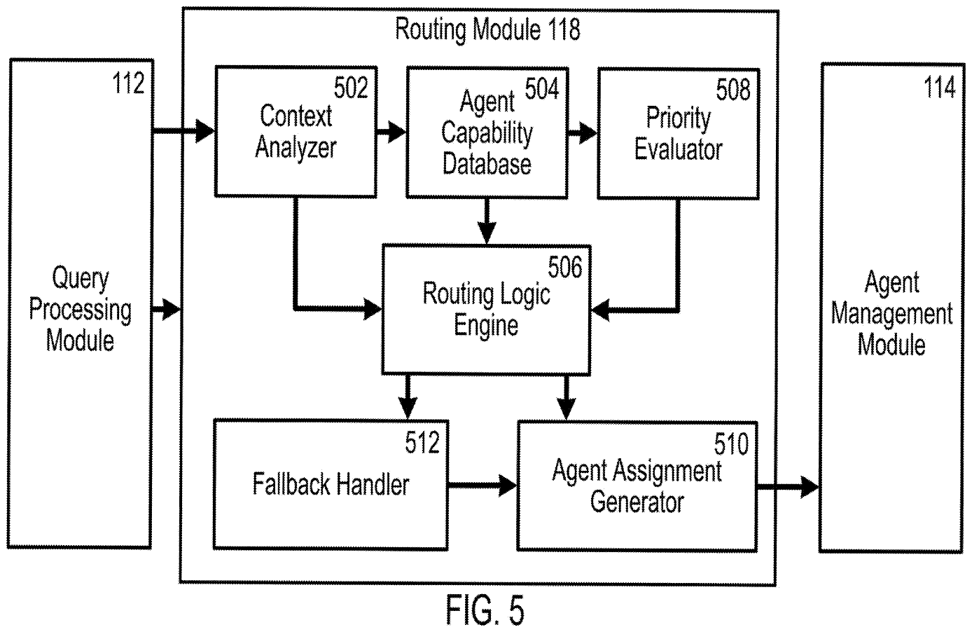

FIG. 5 is a block diagram illustrating the internal architecture of the routing module 118 according to an embodiment of the present disclosure. As introduced with reference to FIGS. 1 and 3, the routing module 118 is responsible for analyzing user queries and contextual information to select the most appropriate processing agent from the agent management module 114. FIG. 5 depicts and embodiment of a decision-making architecture that combines context analysis, capability matching, priority evaluation, and fallback handling to ensure that each user query is routed to an agent optimally suited to handle it.

The routing module 118 receives inputs from the query processing module 112 (which provides ranked retrieval results and query analysis) and outputs agent assignment instructions to the agent management module 114 (which then invokes the selected agent). The routing module 118 includes several interconnected components: a context analyzer 502, an agent capability database 504, a routing logic engine 506, a priority evaluator 508, a fallback handler 512, and an agent assignment generator 510.

The context analyzer 502 receives information from the query processing module 112 and performs analysis to extract features and signals that inform agent selection. The context analyzer 502 may examine multiple dimensions of the user query and conversation state to build a comprehensive understanding of what type of agent is needed.

In some embodiments, the context analyzer 502 performs intent classification, determining the primary purpose or goal of the user query. Intent classification may categorize queries into types such as: informational (seeking knowledge or facts), transactional (requesting an action be performed), navigational (seeking a specific resource or location), conversational (open-ended discussion), troubleshooting (diagnosing or resolving a problem), or creative (generating content or ideas). The identified intent type strongly influences which agents are suitable candidates.

The context analyzer 502 may implement intent classification using machine learning models such as text classifiers (e.g., logistic regression, support vector machines, or neural networks trained on labeled query-intent pairs), few-shot learning with large language models (where a prompt containing example queries and their intents is used to classify new queries), or rule-based pattern matching for well-defined intent categories.

In some embodiments, the context analyzer 502 performs entity extraction, identifying key entities mentioned in the query such as product names, order numbers, dates, locations, person names, or technical terms. The presence of specific entity types may indicate which agents are relevant. For example, detection of an order number entity suggests routing to an order tracking agent, while detection of technical product terminology suggests routing to a technical support agent.

Entity extraction may be implemented using named entity recognition (NER) models such as spaCy's pre-trained NER models, transformer-based models like BERT fine-tuned for NER tasks, or API-based services such as Google Cloud Natural Language API or Amazon Comprehend. In some embodiments, the context analyzer 502 maintains domain-specific entity dictionaries or gazetteers to recognize specialized terminology relevant to the application domain.

The context analyzer 502 may also perform sentiment analysis, determining the emotional tone or urgency of the user query. Queries expressing frustration, urgency, or dissatisfaction may be prioritized for routing to specialized escalation agents or human handoff agents, while neutral or positive queries follow standard routing logic. Sentiment analysis can be implemented using pre-trained sentiment models, lexicon-based approaches (scoring queries based on the presence of positive/negative terms), or language model-based classification.

In some embodiments, the context analyzer 502 analyzes conversation history retrieved from the memory subsystem 104 to understand the broader context of the current query. For example, if the user has been discussing a technical issue over multiple turns, the context analyzer 502 may determine that continuity is important and prefer routing to the same agent that handled previous turns, even if the current query in isolation might suggest a different agent. The context analyzer 502 may track conversation state variables such as active topics, unresolved issues, or user preferences expressed in prior turns.

The context analyzer 502 may also extract query complexity metrics, such as query length, vocabulary sophistication, presence of multiple sub-questions, or ambiguity indicators. Complex queries may be routed to more capable agents (e.g., agents backed by larger language models or agents with access to more extensive tool sets), while simple queries may be routed to lightweight, fast-response agents.

In other embodiments, the context analyzer 502 employs a language model to generate a structured query representation or query embedding that captures semantic meaning in a form suitable for matching against agent capabilities. This representation is passed to the routing logic engine 506 for similarity-based matching.

The context analyzer 502 outputs a structured context representation that includes identified intent, extracted entities, sentiment scores, conversation state, complexity metrics, and any other relevant features. This representation is provided to the routing logic engine 506.

The agent capability database 504 is a data store that maintains metadata describing the capabilities, specializations, and characteristics of each available processing agent in the agent management module 114. This database enables the routing module 118 to match user queries to agents based on what each agent can do, rather than relying solely on predefined routing rules.

In some embodiments, each agent entry in the agent capability database 504 includes a capability description that specifies what types of queries or tasks the agent is designed to handle. Capability descriptions may be expressed as structured tags or categories (e.g., “order_tracking”, “technical_support”, “billing_inquiries”), natural language descriptions (e.g., “This agent handles questions about product specifications and technical details”), or semantic embeddings (vector representations of the agent's capabilities that enable similarity-based matching).

The agent capability database 504 may also store skill inventories for each agent, listing specific skills, tools, or knowledge domains the agent has access to. For example, an agent might have skills listed as: “can query order database”, “can process refund requests”, “has access to product catalog API”, “trained on technical documentation corpus”. The routing logic engine 506 can match required skills (inferred from the query) to agents possessing those skills.

In some embodiments, the agent capability database 504 includes performance metrics for each agent, such as average response time, success rate (percentage of queries successfully resolved), user satisfaction scores, or error rates. These metrics enable the priority evaluator 508 to prefer agents with better historical performance when multiple agents are capable of handling a query.

The agent capability database 504 may store availability status for each agent, indicating whether the agent is currently available, busy, offline, or under maintenance. This prevents routing to agents that cannot currently accept requests. In some embodiments, availability includes capacity information (e.g., current load, maximum concurrent requests), enabling load balancing across multiple instances of the same agent type.

In some embodiments, the agent capability database 504 includes constraint specifications that define when an agent should or should not be used. Constraints may include: required authentication levels (e.g., “only route authenticated users to this agent”), geographic restrictions (e.g., “only for users in EU region”), time-based restrictions (e.g., “only available during business hours”), or prerequisite conditions (e.g., “only route if user has an active subscription”).

The agent capability database 504 may also store agent embeddings, vector representations of each agent's overall capabilities and characteristics. These embeddings can be generated by encoding the agent's capability descriptions, training data, or example queries it handles well using an embedding model. The routing logic engine 506 can then perform similarity matching between query embeddings (from the context analyzer 502) and agent embeddings to identify the best-matching agent.

In some embodiments, the agent capability database 504 is dynamically updated based on agent performance and feedback. For example, if an agent consistently fails to handle certain types of queries, its capability description may be automatically refined to exclude those query types. Conversely, if an agent successfully handles new query types, its capabilities may be expanded.

The agent capability database 504 provides agent capability information to the routing logic engine 506, which uses this information to identify candidate agents and select the optimal agent for the current query.

The routing logic engine 506 is the central decision-making component of the routing module 118. It receives the structured context representation from the context analyzer 502, queries the agent capability database 504 to identify candidate agents, and applies routing logic to select the most appropriate agent.

In some embodiments, the routing logic engine 506 implements rule-based routing, where predefined rules map query characteristics to specific agents. For example, a rule might state: “If intent is ‘order_tracking’ AND entity ‘order_number’ is present, route to order_tracking_agent.” Rule-based routing is deterministic, transparent, and easy to configure for well-defined scenarios.

Rules may be expressed in various formalisms, such as if-then statements, decision trees, or declarative rule languages. In some embodiments, rules are prioritized, with higher-priority rules evaluated first, and the first matching rule determining the routing decision. In other embodiments, multiple matching rules may contribute to a scoring function that ranks candidate agents.

In other embodiments, the routing logic engine 506 implements similarity-based routing, where the query representation (e.g., a query embedding from the context analyzer 502) is compared to agent capability representations (e.g., agent embeddings from the agent capability database 504) using a similarity metric such as cosine similarity. The agent with the highest similarity score is selected. This approach is more flexible than rule-based routing and can handle novel query types that don't match predefined rules, as long as they are semantically similar to queries an agent is designed to handle.

In still other embodiments, the routing logic engine 506 implements machine learning-based routing, where a trained model predicts the optimal agent given query features. The model may be a multi-class classifier (with one class per agent), a ranking model (that scores all agents and selects the highest-scoring one), or a reinforcement learning agent (that learns an optimal routing policy through interaction and feedback).

Training data for machine learning-based routing can be generated from historical routing decisions and outcomes (e.g., which agent was selected, whether the query was successfully resolved, user satisfaction scores). The model learns patterns such as “queries with sentiment score <−0.5 and intent ‘complaint’ should route to escalation_agent” or “queries mentioning product X are best handled by specialist_agent_Y.”

The routing logic engine 506 may also implement multi-agent routing, where a query is routed to multiple agents in parallel or in sequence. For example, a complex query might be decomposed into sub-queries, each routed to a different specialist agent, with results aggregated by a coordinator agent. Alternatively, a query might be routed to a primary agent with a secondary agent on standby to handle overflow or provide a second opinion.

In some embodiments, the routing logic engine 506 implements contextual routing, where routing decisions account for conversation history and state. For example, if the user has been interacting with a specific agent over multiple turns, the routing logic engine 506 may prefer to continue routing to that same agent to maintain continuity, even if the current query in isolation might suggest a different agent. This is sometimes called “sticky routing” or “session affinity.”

The routing logic engine 506 may also implement load balancing, distributing queries across multiple instances of the same agent type to prevent overloading any single instance. Load balancing strategies include round-robin (cycling through instances), least-loaded (routing to the instance with the fewest active requests), or random selection.

In other embodiments, the routing logic engine 506 employs a meta-learning approach, where a higher-level model learns to select among different routing strategies (rule-based, similarity-based, ML-based) depending on query characteristics. For example, the meta-learner might use rule-based routing for simple, well-defined queries and ML-based routing for complex, ambiguous queries.

The routing logic engine 506 identifies one or more candidate agents and passes this information to the priority evaluator 508 for final ranking and selection.

The priority evaluator 508 receives candidate agents from the routing logic engine 506 and applies additional criteria to rank them and select the final agent to handle the query. While the routing logic engine 506 focuses on capability matching (can this agent handle the query?), the priority evaluator 508 focuses on optimization (which agent should handle the query given multiple viable options?).

In some embodiments, the priority evaluator 508 implements performance-based prioritization, ranking candidate agents based on historical performance metrics retrieved from the agent capability database 504. Agents with higher success rates, faster response times, or better user satisfaction scores are ranked higher. This ensures that when multiple agents are capable of handling a query, the system prefers the agent most likely to provide a high-quality response.

The priority evaluator 508 may compute a composite performance score for each candidate agent using a weighted combination of metrics: priority_score(agent)=w₁×success_rate+w₂×(1/avg_response_time)+w₃×user_satisfaction−w₄×error_rate, where w₁, w₂, w₃, w₄ are configurable weights reflecting the relative importance of each metric.

In some embodiments, the priority evaluator 508 implements cost-based prioritization, considering the computational or financial cost of invoking each agent. For example, agents backed by large, expensive language models (e.g., GPT-4) may be deprioritized in favor of smaller, cheaper models (e.g., GPT-3.5) when both are capable of handling the query. Cost-based prioritization enables the system to balance quality and efficiency.

The priority evaluator 508 may also implement availability-based prioritization, preferring agents that are currently available and have capacity to handle additional requests. Agents that are busy, overloaded, or offline are deprioritized or excluded.

In some embodiments, the priority evaluator 508 implements policy-based prioritization, applying business rules or policies that override capability-based selection. For example, a policy might state: “Always route VIP customers to premium_support_agent regardless of query type,” or “During peak hours, deprioritize resource-intensive agents to preserve system capacity.” Policy-based prioritization ensures that routing decisions align with business objectives and operational constraints.

The priority evaluator 508 may also consider user preferences retrieved from the memory subsystem 104. For example, if a user has previously indicated a preference for detailed technical explanations, the priority evaluator 508 may boost the priority of agents known to provide detailed responses. Conversely, if a user prefers concise answers, agents optimized for brevity are prioritized.

In other embodiments, the priority evaluator 508 implements multi-objective optimization, balancing multiple competing objectives such as response quality, response time, cost, and user satisfaction. Multi-objective optimization techniques such as Pareto optimization or weighted scalarization can be used to identify the agent that provides the best overall tradeoff.

The priority evaluator 508 outputs a ranked list of candidate agents, with the top-ranked agent designated as the primary selection. This selection is passed to the agent assignment generator 510. If the primary agent fails or is unavailable, the routing logic engine 506 may invoke the fallback handler 512.

The fallback handler 512 is invoked when the routing logic engine 506 is unable to identify a suitable agent, when the selected agent is unavailable, or when the selected agent fails to successfully process the query. The fallback handler 512 implements strategies to ensure that the user receives a response even in failure scenarios.

In some embodiments, the fallback handler 512 implements default agent routing, where queries that cannot be matched to a specific agent are routed to a general-purpose agent capable of handling a wide range of query types. The default agent may be a large, capable language model with broad knowledge, or a conversational agent designed to handle miscellaneous queries.

In other embodiments, the fallback handler 512 implements escalation routing, where queries that cannot be handled by automated agents are routed to a human operator or a specialized escalation agent. Escalation may be triggered by explicit user requests (e.g., “I want to speak to a human”), by detection of high frustration or urgency in the query, or by repeated failures of automated agents to resolve the user's issue.

The fallback handler 512 may also implement graceful degradation, where if the optimal agent is unavailable, the system routes to a less-optimal but still capable agent. For example, if a specialized technical support agent is offline, the fallback handler 512 might route to a general support agent with instructions to focus on technical issues.

In some embodiments, the fallback handler 512 implements retry logic, where if an agent fails to process a query (e.g., due to a timeout, API error, or exception), the fallback handler 512 retries with the same agent or routes to an alternative agent. Retry logic may include exponential backoff (increasing delays between retries) and maximum retry limits to prevent infinite loops.

The fallback handler 512 may also generate user-facing error messages or apology responses when no suitable agent can be found or when all agents fail. These messages may explain the issue (e.g., “I'm sorry, I'm unable to process your request at the moment due to a technical issue”) and suggest alternatives (e.g., “Please try again later or contact support at [email]”).

In other embodiments, the fallback handler 512 logs fallback events and analyzes patterns to identify gaps in agent coverage. For example, if certain types of queries frequently trigger fallback, this indicates a need for a new specialized agent or expansion of existing agent capabilities. The fallback handler 512 may generate reports or alerts to system administrators highlighting these gaps.

The fallback handler 512 provides fallback routing decisions to the agent assignment generator 510, ensuring that every query receives a response even in edge cases or failure scenarios.

The agent assignment generator 510 receives the final agent selection from the priority evaluator 508 (or from the fallback handler 512 in fallback scenarios) and generates an agent assignment instruction that is sent to the agent management module 114. The agent assignment instruction specifies which agent should handle the query and may include additional context or parameters to guide the agent's processing.

In some embodiments, the agent assignment generator 510 constructs an assignment message that includes: the identifier of the selected agent (e.g., agent ID or agent name), the user query, relevant context retrieved from the memory subsystem 104 (e.g., conversation history, user preferences, retrieved documents), and any routing metadata (e.g., intent classification, extracted entities, priority score).

The agent assignment generator 510 may also include agent-specific instructions or configuration parameters in the assignment message. For example, if the priority evaluator 508 determined that the user prefers concise responses, the assignment message might include a parameter instructing the agent to generate brief answers. If the query is high-priority or urgent, the assignment message might include a flag indicating expedited processing.

In some embodiments, the agent assignment generator 510 implements context packaging, where relevant information from the memory subsystem 104 and query processing module 112 is formatted and packaged in a way optimized for the selected agent's input requirements. For example, if the agent is a language model-based agent, the context packaging might involve constructing a prompt that includes the user query, conversation history, and retrieved documents in a specific format.

The agent assignment generator 510 may also implement session management, creating or updating session state that tracks which agent is handling the current conversation. This session state is used by the routing logic engine 506 for contextual routing in subsequent turns (e.g., maintaining continuity with the same agent).

In some embodiments, the agent assignment generator 510 logs the routing decision for auditing, analytics, and model training purposes. The log entry may include the query, the selected agent, the reasoning or scores that led to the selection, and eventually the outcome (success or failure). This logged data can be used to train or refine machine learning models in the routing logic engine 506 or priority evaluator 508.

The agent assignment generator 510 sends the agent assignment instruction to the agent management module 114, which invokes the selected processing agent to handle the user query. The agent processes the query using the provided context and generates a response, which is ultimately returned to the user via the user interface 120 (FIG. 1).

In operation, the routing module 118 functions as follows: The query processing module 112 provides query information and retrieval results to the context analyzer 502. The context analyzer 502 performs intent classification, entity extraction, sentiment analysis, and other contextual analysis, producing a structured context representation.

This context representation is passed to the routing logic engine 506, which queries the agent capability database 504 to retrieve information about available agents and their capabilities. The routing logic engine 506 applies routing logic (rule-based, similarity-based, ML-based, or hybrid) to identify candidate agents capable of handling the query.

The candidate agents are passed to the priority evaluator 508, which ranks them based on performance metrics, cost, availability, policies, and user preferences. The priority evaluator 508 selects the top-ranked agent as the primary selection.

If the routing logic engine 506 cannot identify suitable candidates, or if the selected agent is unavailable or fails, the fallback handler 512 is invoked to implement fallback strategies such as default agent routing, escalation, or graceful degradation.

The final agent selection (from the priority evaluator 508 or fallback handler 512) is passed to the agent assignment generator 510, which constructs an agent assignment instruction including the query, context, and any agent-specific parameters. This instruction is sent to the agent management module 114, which invokes the selected agent to process the query and generate a response.

This sophisticated routing architecture ensures that user queries are intelligently matched to the most appropriate processing agents based on capabilities, performance, context, and business policies, while providing robust fallback mechanisms to handle edge cases and failures. The result is a system that delivers high-quality, contextually appropriate responses across a wide range of query types and scenarios.

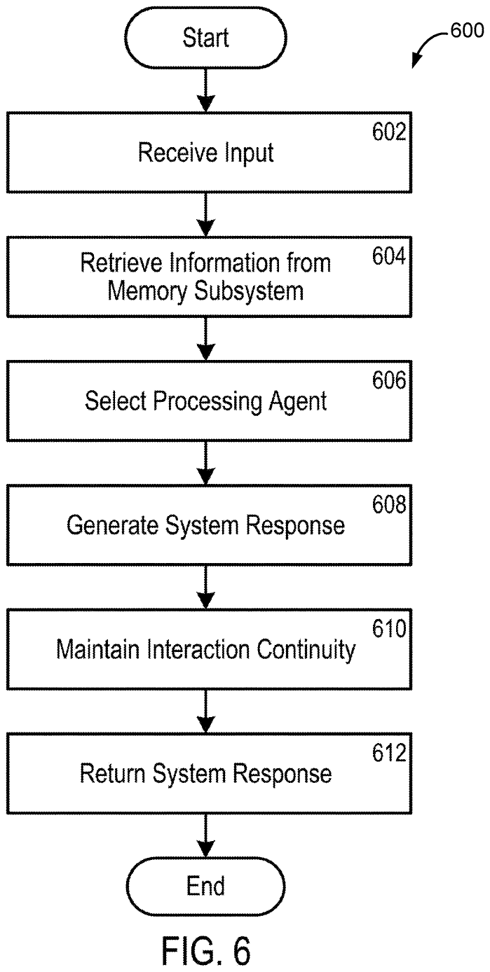

FIG. 6 is a flowchart illustrating one embodiment of a method for managing automated interactions with adaptive memory according to an embodiment of the present disclosure. The method 600 represents the high-level operational flow of the system 100 described with reference to FIGS. 1-5, showing how user inputs are received, processed using memory-augmented agent selection, and responded to with continuity across interactions.

The method 600 begins at a start state and proceeds through a series of operations that collectively implement intelligent, context-aware automated interaction management.

At operation 602, the system receives input from a user via a user interface. The input may be text (e.g., a typed message, search query, or command), voice (e.g., spoken utterance captured via microphone and converted to text via speech recognition), or other modalities such as images, files, or structured data submissions. In some embodiments, receiving input includes preprocessing operations such as text normalization, language detection, or input validation. For voice inputs, operation 602 may include invoking a speech-to-text service to convert audio to text before further processing. The received input represents a user query, request, or conversational turn that the system must process and respond to. The input is passed to subsequent operations for analysis and processing.

At operation 604, the system retrieves relevant information from the memory subsystem to provide context for processing the user input. This operation implements the retrieval functionality described with reference to FIGS. 2 and 4. In some embodiments, operation 604 includes generating a query representation (e.g., query embedding) from the user input and performing hybrid search combining keyword-based retrieval (e.g., BM25) and vector-based semantic search (e.g., approximate nearest neighbor search in the vector database). The retrieval process accesses both the first memory component (short-term contextual memory with time-decayed relevance) and the second memory component (long-term episodic memory of significant interaction events). Step 604 may also include re-ranking retrieved candidates using cross-encoder models and integrating additional contextual factors such as conversation history, user preferences, and temporal relevance. The output of operation 604 is a ranked set of relevant information items that provide context for understanding and responding to the user input. In some embodiments, operation 604 triggers memory access operations that refresh the relevance of accessed items, resetting decay timers and applying relevance boosts as described with reference to FIG. 2. This implements the spaced repetition mechanism whereby frequently accessed information maintains high relevance.

At operation 606, the system selects an appropriate processing agent to handle the user input based on the input itself and the retrieved contextual information. This operation implements the routing functionality described with reference to FIG. 5. In some embodiments, operation 606 includes analyzing the user input to extract features such as intent, entities, sentiment, and complexity. The system queries an agent capability database to identify candidate agents whose capabilities match the requirements inferred from the input. Candidate agents are ranked based on performance metrics, cost, availability, and policy constraints, and the top-ranked agent is selected. Step 606 may also implement contextual routing, where the system considers conversation history to maintain continuity with a previously selected agent if appropriate. If no suitable agent can be identified, operation 606 may invoke fallback handling to route to a default agent or escalation path. The selected processing agent is the agent determined to be best suited to generate a high-quality, contextually appropriate response to the user input.

At operation 608, the selected processing agent generates a system response to the user input using the retrieved contextual information from operation 604. The processing agent may be a rule-based system, a language model-based agent, or an agent with tool-use capabilities as described with reference to FIG. 3. In some embodiments, operation 608 includes constructing a prompt or input representation for the processing agent that incorporates the user input, retrieved context, conversation history, and any agent-specific instructions. The agent processes this input and generates a response, which may be text, structured data, or instructions to perform actions (e.g., API calls, database updates). For language model-based agents, operation 608 may include invoking an LLM API with a carefully constructed prompt, receiving the model's output, and post-processing the output (e.g., formatting, safety filtering, citation extraction). The generated system response is designed to address the user's input in a contextually appropriate, accurate, and helpful manner.

At operation 610, the system performs operations to maintain continuity across the current and future interactions. This operation implements the memory storage and update functionality described with reference to FIG. 2. In some embodiments, operation 610 includes storing the current interaction turn (user input and system response) in the first memory component as a new interaction data item with associated relevance attributes and decay parameters. The stored interaction becomes part of the contextual memory available for future retrievals. Step 610 may also include updating relevance attributes of previously stored items based on the current interaction. For example, if the current interaction referenced or built upon information from a previous turn, the relevance of that previous information may be boosted. In some embodiments, operation 610 includes evaluating whether any information from the current interaction should be promoted to the second memory component (long-term episodic memory) based on salience criteria. Significant events, explicit user preferences, or important facts may be extracted and stored as persistent interaction events. Step 610 may also include conflict resolution operations, where the system detects and resolves contradictions between new information and previously stored information, potentially triggering asynchronous update/merge events as described in the epistemic hierarchy approach. By maintaining interaction continuity, the system ensures that future interactions benefit from the context and knowledge accumulated in the current interaction, creating a coherent, personalized user experience over time.

At operation 612, the system returns the generated system response to the user via the user interface. The response may be displayed as text, rendered as rich media (e.g., images, charts, formatted documents), converted to speech via text-to-speech synthesis, or presented in other modalities appropriate to the user interface. In some embodiments, operation 612 includes response formatting operations such as applying markdown rendering, syntax highlighting for code, or interactive elements (e.g., buttons, links, forms). The response may also include citations or references to sources used in generating the response. Step 612 completes the interaction cycle, providing the user with the information or assistance they requested. The method then proceeds to an end state, though in practice the system typically returns to operation 602 to await the next user input, creating a continuous interaction loop.

The method 600 may be varied in numerous ways while remaining within the scope of the present disclosure. In some embodiments, operations 604 and 606 are performed in parallel or with partial overlap, where retrieval and agent selection begin simultaneously based on initial analysis of the user input, with agent selection refining its decision as retrieval results become available. In some embodiments, the method 600 includes additional operations such as user authentication (verifying user identity before processing sensitive requests), input validation (checking that the input is well-formed and safe to process), or response approval (requiring user confirmation before executing certain actions). In some embodiments, the method 600 includes feedback collection operations, where the system solicits explicit feedback from the user (e.g., thumbs up/down, satisfaction rating) or observes implicit feedback signals (e.g., whether the user reformulated their query, whether they engaged with the response). This feedback is used to update agent performance metrics, refine routing models, or adjust memory decay parameters. In some embodiments, the method 600 is implemented in a distributed or asynchronous manner, where different operations execute on different computing resources or with different timing. For example, operation 604 (retrieval) might execute on a dedicated search cluster, operation 606 (agent selection) on a routing service, and operation 608 (response generation) on GPU-accelerated inference servers.

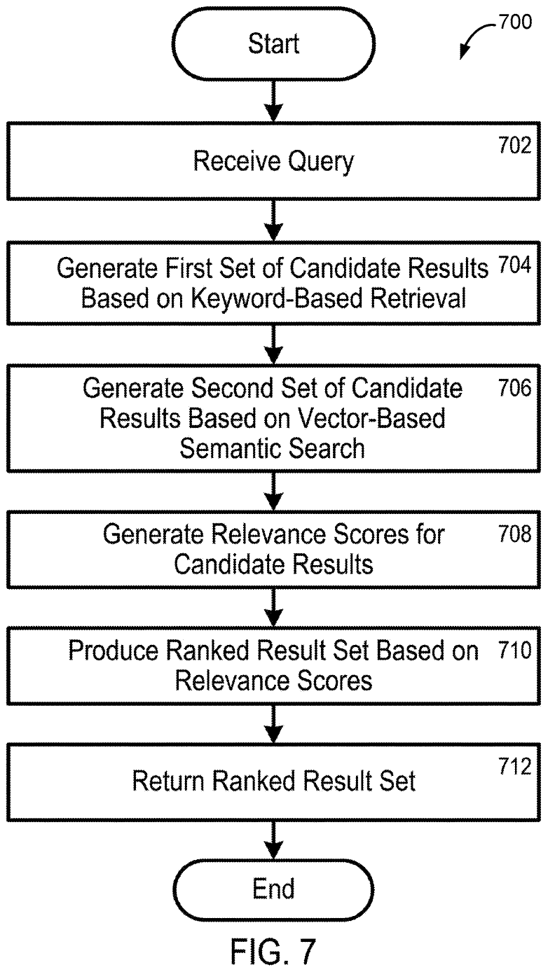

FIG. 7 is a flowchart illustrating one embodiment of a method for performing hybrid search combining sparse keyword-based retrieval and dense vector-based semantic search according to an embodiment of the present disclosure. The method 700 represents a detailed view of the retrieval operations performed by the query processing module 112 as described with reference to FIG. 4, showing how the system leverages complementary retrieval strategies to maximize both precision and recall.

The method 700 begins at a start state and proceeds through a series of operations that implement the hybrid search architecture combining the strengths of keyword matching and semantic similarity.

At operation 702, the system receives a query from a user or from another system component. The query may be a natural language question, a search phrase, a set of keywords, or any textual input for which relevant information must be retrieved from the memory subsystem. In some embodiments, receiving the query includes preprocessing operations such as tokenization, normalization (e.g., lowercasing, removing punctuation), stopword removal, or stemming/lemmatization. The query serves as the basis for both keyword-based and vector-based retrieval operations in subsequent operations.

At operation 704, the system generates a first set of candidate results based on keyword-based retrieval. This operation implements the functionality of the keyword search engine 404 described with reference to FIG. 4. In some embodiments, operation 704 includes extracting query terms from the received query and performing a lookup in an inverted index that maps terms to documents or memory items containing those terms. The system applies a keyword-based scoring function such as BM25 (Best Matching 25) or TF-IDF (Term Frequency-Inverse Document Frequency) to rank documents based on term frequency, inverse document frequency, and document length normalization. The BM25 scoring function, for example, computes a score for each document based on how often query terms appear in the document, how rare those terms are across the entire corpus, and the length of the document relative to the average document length. Step 704 may also implement fuzzy matching to handle misspellings or variations, using techniques such as edit distance (Levenshtein distance) to match query terms to similar terms in the index. The output of operation 704 is a first set of candidate results, typically the top-k documents according to the keyword-based scoring function (e.g., the top 100 results by BM25 score). This first set emphasizes precision for exact-match queries and is particularly effective for queries involving specific identifiers such as order numbers, case IDs, product SKUs, or technical part numbers where exact keyword matching is critical.

At operation 706, the system generates a second set of candidate results based on vector-based semantic search. This operation implements the functionality of the vector search engine 406 described with reference to FIG. 4. In some embodiments, operation 706 includes generating a query embedding by encoding the received query using an embedding model such as a sentence transformer (e.g., all-MiniLM-L6-v2, all-mpnet-base-v2), a domain-specific fine-tuned model, or a general-purpose embedding model (e.g., OpenAI text-embedding-ada-002, Cohere embed-english-v3.0). The query embedding is a dense vector representation (e.g., 384-dimensional, 768-dimensional, or 1536-dimensional) that captures the semantic meaning of the query in a continuous vector space. The system then performs approximate nearest neighbor (ANN) search in a vector database (e.g., using FAISS, Pinecone, Weaviate, or Milvus) to identify documents or memory items whose embeddings are most similar to the query embedding according to a distance metric such as cosine similarity, Euclidean distance, or dot product. The output of operation 706 is a second set of candidate results, typically the top-k documents according to vector similarity scores (e.g., the top 100 results by cosine similarity). This second set emphasizes recall and semantic understanding, effectively retrieving documents that are conceptually related to the query even if they do not contain exact keyword matches. Vector-based search is particularly effective for natural language queries, paraphrased questions, or queries where the user's intent is expressed in different terminology than the stored documents.

At operation 708, the system generates relevance scores for the candidate results from both the first set (keyword-based) and the second set (vector-based). This operation implements the functionality of the result merger 408 and relevance scorer 410 described with reference to FIG. 4. In some embodiments, operation 708 includes normalizing the scores from the keyword search engine and the vector search engine to a common scale, since these scores may be computed using different metrics and may have different ranges. Normalization techniques may include min-max scaling (mapping scores to a 0-1 range), z-score normalization (standardizing to mean 0 and standard deviation 1), or rank-based normalization (converting scores to percentile ranks). After normalization, operation 708 combines the normalized keyword score and normalized vector score for each candidate using a fusion strategy. In some embodiments, the fusion strategy is a weighted linear combination where the final relevance score is computed as: relevance_score=α×normalized_keyword_score+β×normalized_vector_score, where α and β are configurable weights that control the relative importance of keyword matching versus semantic similarity. In other embodiments, the fusion strategy is reciprocal rank fusion (RRF), where the relevance score is based on the reciprocal of the rank positions of the candidate in each result set. Step 708 may also include applying a cross-encoder re-ranking model, where a transformer-based model (e.g., a BERT-based cross-encoder) directly scores the relevance of each candidate document to the query by processing the query-document pair jointly. Cross-encoder re-ranking provides more accurate relevance scores than independent keyword and vector scores but is computationally expensive, so it is typically applied only to the top candidates from the merged set. In some embodiments, operation 708 also incorporates additional relevance factors such as recency (boosting more recent documents), user preferences (boosting documents matching user-specific criteria), or source authority (boosting documents from trusted sources). The output of operation 708 is a set of candidate results with unified relevance scores that reflect both keyword matching precision and semantic similarity recall.

At operation 710, the system produces a ranked result set based on the relevance scores generated in operation 708. The candidates are sorted in descending order of relevance score, with the most relevant items appearing first. In some embodiments, operation 710 includes applying diversity or deduplication filters to ensure that the ranked result set contains a variety of relevant information rather than redundant near-duplicates. Diversity techniques may include maximal marginal relevance (MMR), which iteratively selects results that are both relevant to the query and dissimilar to already-selected results, or clustering-based selection, which ensures representation from multiple topical clusters. Step 710 may also apply result count limiting, returning only the top-N results (e.g., top 10, top 20) to avoid overwhelming the downstream processing agent or user with excessive information. The ranked result set represents the final output of the hybrid search process, combining the precision of keyword-based retrieval with the recall and semantic understanding of vector-based retrieval.

At operation 712, the system returns the ranked result set to the requesting component, which may be the routing module 118 (for agent selection), a processing agent (for context assembly), or directly to the user interface 120 (for search results display). The ranked result set provides the contextual information needed to generate informed, accurate responses to user queries. The method then proceeds to an end state, completing the hybrid search operation.

The method 700 may be varied in numerous ways while remaining within the scope of the present disclosure. In some embodiments, operations 704 and 706 are performed in parallel, with keyword-based retrieval and vector-based retrieval executing concurrently to minimize latency. In some embodiments, the method 700 includes additional retrieval strategies beyond keyword and vector search, such as graph-based retrieval (traversing knowledge graph relationships), metadata filtering (restricting results based on structured attributes), or temporal retrieval (prioritizing results from specific time periods). In some embodiments, the fusion weights α and β in operation 708 are dynamically adjusted based on query characteristics, for example, increasing the weight of keyword search for queries containing specific identifiers and increasing the weight of vector search for open-ended natural language queries. In some embodiments, the method 700 includes feedback loops where user interactions with the ranked results (e.g., which results were clicked, which were ignored) are used to refine relevance scoring models or adjust fusion parameters over time.

The method 700 represents an effective approach to information retrieval that leverages the complementary strengths of sparse keyword-based methods and dense vector-based methods, ensuring robust performance across diverse query types and information needs.

The flowcharts presented herein illustrate processes and operations with reference to specific components from the system architectures shown in earlier figures. These component references are provided for illustrative purposes and should not be construed as limiting the disclosed processes to the particular architectural implementations shown. The processes may be performed using alternative components, different system architectures, or other suitable implementations that accomplish the described functions.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by a phrase such as “at least one of” or “one or more of” indicates an inclusive list such that, for example, “at least one of A, B, or C” means A or B or C or AB or AC or BC or ABC (i.e., A and B and C). Also, as used herein, the phrase “based on” shall not be construed as a reference to a closed set of conditions. For example, an exemplary operation that is described as “based on condition A” may be based on both a condition A and a condition B without departing from the scope of the present disclosure. In other words, as used herein, the phrase “based on” shall be construed in the same manner as the phrase “based at least in part on.” Similarly, the phrase “in response to” does not require that the identified event or condition be the sole trigger for the described action.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Numerical values, thresholds, ranges, and quantities provided herein, including but not limited to confidence thresholds, weight values, retention factors, learning factors, staleness periods, sample size thresholds, and iteration limits, are illustrative of particular embodiments and are not intended to limit the scope of the described systems and processes to those specific values. In various embodiments, different numerical values may be used, and the specific values may be configurable per deployment, per content type, or per domain.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

We claim:

1. A system to automate interaction management, the system comprising:
a processor;
a memory subsystem coupled to the processor, the memory subsystem comprising:
a first memory component configured to store interaction data, wherein a relevance attribute associated with the interaction data attenuates over time;
a second memory component configured to store interaction events; and
a query processing module implemented by the processor and configured to retrieve information from at least one of the first memory component and the second memory component;
an agent management module implemented by the processor and configured to maintain one or more processing agents;
a routing module implemented by the processor and configured to select at least one processing agent from the one or more processing agents based at least in part on information retrieved from the memory subsystem; and
a response generation module implemented by the processor and configured to produce system responses utilizing the at least one selected processing agent and retrieved information, wherein interaction continuity is maintained across multiple interactions independent of session boundaries.

2. The system of claim 1, wherein the relevance attribute attenuates logarithmically based on elapsed time.

3. The system of claim 1, wherein the query processing module is configured to implement a retrieval-augmented generation pipeline.

4. The system of claim 3, wherein the query processing module is configured to implement a sparse-dense hybrid search combining sparse retrieval for exact keyword matches with dense vector search for semantic similarity.

5. The system of claim 4, further comprising a cross-encoder re-ranker implemented by the processor and configured to generate relevance scores for results from the sparse retrieval and the dense vector search.

6. The system of claim 1, wherein accessing interaction data in the first memory component resets an elapsed time parameter associated with the interaction data and applies a boost to the relevance attribute.

7. The system of claim 1, wherein a decay parameter governing attenuation of the relevance attribute is dynamically adjusted based on interaction patterns.

8. The system of claim 1, further comprising a conflict resolution module implemented by the processor and configured to resolve contradictions between the first memory component and the second memory component by prioritizing the first memory component when the relevance attribute exceeds a threshold.

9. The system of claim 1, wherein the first memory component comprises a vector database storing embeddings of the interaction data.

10. The system of claim 1, wherein the routing module is configured to select the at least one processing agent based on a policy defining agent capabilities and routing rules.

11. The system of claim 7, wherein the interaction patterns comprise access frequency, recency of access, and session duration.

12. The system of claim 1, wherein the response generation module is configured to generate the system responses by providing the retrieved information and a user input to the at least one selected processing agent as context.

13. A computer-implemented method for automated interaction management, the method comprising:
receiving an input;
retrieving, by a processor, information from a memory subsystem based at least in part on the input using a retrieval-augmented generation pipeline, wherein the memory subsystem comprises a first memory component storing interaction data with a relevance attribute that attenuates over time, and the memory subsystem comprises a second memory component storing interaction events;
selecting, by a processor, at least one processing agent from one or more processing agents based at least in part on the retrieved information;
generating, by a processor, a system response utilizing the at least one selected processing agent and the retrieved information; and
maintaining interaction continuity across multiple interactions independent of session boundaries.

14. The method of claim 13, wherein retrieving information comprises implementing a sparse-dense hybrid search combining sparse retrieval for exact keyword matches with dense vector search for semantic similarity.

15. The method of claim 13, wherein maintaining interaction continuity comprises resetting an elapsed time parameter associated with accessed interaction data and applying a boost to the relevance attribute.

16. The method of claim 13, further comprising dynamically adjusting a decay parameter governing attenuation of the relevance attribute based on interaction patterns.

17. The method of claim 13, wherein retrieving information comprises accessing both the first memory component and the second memory component and prioritizing results from the first memory component when the relevance attribute exceeds a threshold.

18. The method of claim 14, wherein implementing the sparse-dense hybrid search further comprises applying a cross-encoder re-ranker to generate relevance scores for results from the sparse retrieval and the dense vector search.

19. The method of claim 13, wherein the first memory component comprises a vector database storing embeddings of the interaction data.

20. A non-transitory computer-readable storage medium storing instructions that, when executed by a processor, cause the processor to:
receive an input;
retrieve information from a memory subsystem based at least in part on the input using a retrieval-augmented generation pipeline, wherein the memory subsystem comprises a first memory component storing interaction data with a relevance attribute that attenuates over time and a second memory component storing interaction events;
select at least one processing agent from one or more processing agents based at least in part on the retrieved information;
generate a system response utilizing the at least one selected processing agent and the retrieved information; and
maintain interaction continuity across multiple interactions independent of session boundaries.
